(19) United States
(12) Patent Application Publication
(10) Pub. No.: US 2012/0009514 A1
(43) Pub. Date: Jan. 12, 2012

(54) IMAGE FORMING METHOD, TWO-COMPONENT DEVELOPER, IMAGE FORMING APPARATUS AND PROCESS CARTRIDGE

(76) Inventors: Masashi Nagayama, Shizuoka (JP); Mitsuo Aoki, Shizuoka (JP); Hideyuki Santo, Shizuoka (JP); Shigenori Yaguchi, Shizuoka (JP)

(21) Appl. No.: 13/153,877

(22) Filed: Jun. 6, 2011

(30) Foreign Application Priority Data
Jul. 7, 2010 (JP) 2010-155195
Apr. 1, 2011 (JP) 2011-081535

(51) Int. Cl. G03G 9/00; G03G 13/22; G03G 21/18; G03G 15/01

(52) U.S. Cl. 430/105; 430/124.1; 399/223; 399/111; 399/252

(57) ABSTRACT

In the image forming method, at least one color toner image and a transparent toner image are formed using a color developer including a color toner and a carrier and contained in a first developing device, and a second developer including a transparent toner and a carrier and contained in a second developing device. A supplementary developer is supplied at least to the second developing device while discharging excess of the developer in the developing device. The transparent toner includes a lubricant and has a viscoelastic property such that a loss tangent (tan δ), which is defined as a ratio (G″/G′) of loss modulus (G″) to storage modulus (G′), has a peak at a temperature of from 80° C. to 160° C. and the peak has a height of not less than 3.

### BACKGROUND OF THE INVENTION

1. Field of the Invention

The present invention relates to an image forming method for forming at least one color toner image and a transparent toner image. In addition, the present invention also relates to a two-component developer for use in the image forming method. Further, the present invention relates to an image forming apparatus and a process cartridge using the image forming method.

2. Description of the Related Art

Electrophotographic image forming methods used for dry image forming apparatuses such as laser printers, copiers and facsimiles typically include the following processes:

(1) charging the surface of an image bearing member such as a photoreceptor (charging process);
(2) irradiating the charged image bearing member with light so that the charges of the irradiated portions decay, thereby forming an electrostatic latent image on the image bearing member (irradiating process);
(3) developing the electrostatic latent image with a developer including a charged dry toner to form a visible toner image on the image bearing member (developing process);
(4) transferring the toner image to a recording material such as a paper sheet (transferring process);
(5) fixing the toner image to the recording material upon application of heat and/or pressure (fixing process); and
(6) cleaning the surface of the image bearing member so that the image bearing member is ready for the next image forming operation.

Recently, there is an increasing need for an image forming apparatus capable of performing high speed image formation while saving fixing energy. Therefore, toner capable of melting at a relatively low temperature is needed. Since a low temperature fixable toner has can be easily melted, the low temperature fixable toner is preferably used as a transparent toner because a glossy image can be formed with low fixing energy. However, when a low temperature fixable toner is prepared merely by decreasing the melting point of the toner, the toner tends to cause a problem in that the preservability of the toner deteriorates. In addition, when the toner is used for a two-component developer in combination with a carrier, the toner tends to cause a spent toner problem in that the toner adheres to the surface of the carrier when the developer is agitated in a developing device, thereby deteriorating the charging ability of the carrier.

Further, recent image forming apparatuses are required to produce high quality images, and when a pictorial image is formed, a technique in that high glossiness is imparted to the surface of a recording material is used to produce a clear glossy image.

In order to impart high glossiness to the surface of a recording material, a technique in that a transparent toner is applied to anon-image area of a color image on a recording material to decrease the difference in glossiness between the color image area and the non-image area; a technique in that a transparent toner is applied to the entire surface of a recording material; etc., have been proposed. In addition, a technique in that a color toner image and a transparent toner image are formed on a recording material, and the images are heated by a fixing device, followed by cooling and peeling from the fixing device to prepare a glossy image is proposed. Using these techniques make it possible to produce copies having little difference in glossiness between an image area and a non-image area.

By contrast, in the printing field, treatments such as UV varnish printing, varnishing, and polypropylene film laminating are performed to control the glossiness of a desired portion of a printed recording material. For example, a technique in that after performing a usual printing operation, an additional spot printing operation is performed on a desired portion of the print using an additionally prepared plate and a UV varnish or the like to impart high glossiness to the portion is used. By using this technique, a print in which the portion subjected to the spot printing operation has as high glossiness as photographs and other portions thereof have relatively low glossiness can be produced. Namely, the print has large glossiness difference, and therefore the print can be differentiated from normal prints.

However, when such a print is produced using an offset printing method, it is necessary to prepare an additional plate for forming such a glossy portion. In addition, this method cannot be used for producing a small number of prints due to increase of running costs, i.e., the method can be used only for producing a large number of prints. Since electrophotography can perform image formation without using a plate, it becomes possible to produce such prints even when the number of the prints is small.

In attempting to produce images having different glossiness using electrophotography, a method in which a color toner image is formed on a recording material using at least one color toner (such as yellow, magenta or cyan toner) and a transparent toner, wherein an image portion having the transparent toner image has glossiness different from the glossiness of the color image portion by ±20% or more due to difference of the melting points of the color toner and the transparent toner; a method in which after a fixed color toner image is formed, an image is formed using a transparent toner while decreasing the fixing temperature to prepare an image portion having high glossiness and another image portion having relatively low glossiness; and a method in which initially a fixed glossy image is formed and then a non-glossy image is formed, followed by fixing, have been proposed. By using these methods, a copy having portions with different glossiness can be produced, but the glossiness of a glossy image portion of the copy is lower than the glossy portion of a pictorial print formed by the above-mentioned spot printing method.

Electrophotographic image forming apparatuses use a one-component developing device which develops an electrostatic latent image on an image bearing member with a one-component developer including a toner including a magnetic material, or a two-component developing device which develops an electrostatic latent image on an image bearing member with a two-component developer including a toner and a carrier. Among these developing devices, two-component developing devices are broadly used because of having better developing properties than one-component developing devices. Particularly, recently two-component developing devices are typically used for full color image forming apparatuses or multi-color image forming apparatuses.

The above-mentioned methods using a transparent toner often use a two-component developing method.

In image forming apparatuses using a two-component developing method, a toner and a carrier are agitated in a developing device, so that the carrier imparts a charge to the toner. In this regard, the toner is electrostatically adhered to the surface of the carrier, and the carrier bearing the toner thereon is fed to a developing region. Since a development bias is applied to the developer (i.e., the toner and carrier) in the developing region, the toner is separated from the carrier, and the toner is electrostatically adhered to an electrostatic latent image on an image bearing member, resulting in formation of a toner image on the image bearing member.

It is preferable for the two-component developing methods that the carrier stably imparts a constant amount of charge to the toner when the developer is agitated in a developing device in order to produce high quality images over a long period of time. Therefore, the carrier is required to maintain a good charge imparting ability over a long period of time.

However, in general two-component developing devices, toner is consumed for developing electrostatic latent images while carrier remains in the developing devices without being consumed. Therefore, the carrier is continuously agitated with toner particles in the developing devices, and the carrier tends to degrade as the agitation period is lengthened. Specifically, a problem in that a resin layer formed on the surface of the carrier (coated carrier) is peeled therefrom and the spent toner problem in that the toner is adhered to the surface of the carrier are caused. As a result, the electric resistance of the carrier decreases, and the charge of the developer (toner) decreases (i.e., the developing property of the developer is excessively enhanced), resulting in occurrence of a background development problem in that the background of images is soiled with toner particles, and/or formation of images having an excessively high image density.

In attempting to solve the problems, a developing device (so-called “trickle” developing device) is proposed, in which a small amount of carrier is supplied to the developer in the developing device together with a supplementary toner to replace part of the carrier in the developing device with the fresh carrier particles and to compensate the toner used for development so that change of charge quantity of the developer (toner) is decreased and images having constant image quality (such as image density) are produced. However, even when such a trickle developing device is used, the ratio of degraded carrier particles increases as the developer in the developing device is used over a long period of time. Therefore, it is difficult for the developing device to prevent occurrence of the above-mentioned problems such as the background development problem and the excessively high image density problem.

In addition, in attempting to prevent deterioration of the charge property of developer and image qualities, a developing method in which a small amount of carrier having a higher resistance than the carrier in a developing device is supplied to the developer in the developing device together with a supplementary toner; and a developing method in which a small amount of carrier having a higher charge imparting ability than the carrier in a developing device is supplied to the developer in the developing device together with a supplementary toner, have been proposed. However, in these methods, the amount of the replaced carrier changes depending on the toner consumption, and therefore the ratio of the fresh carrier in the carrier in the developing device always changes, resulting in change of the resistance or charge imparting ability of the carrier in the developing device, thereby causing the above-mentioned problems such as the background development problem and the excessively high image density problem.

Further, there is a proposal for a developing method in which several kinds of supplementary developers each including a toner and a carrier and contained in one container while separated from each other are sequentially supplied to a developing device, wherein the carriers included in the supplementary developers have physical properties different from each other and different from that of the developer included in the developing device. However, it is difficult to sequentially supply the several kinds of supplementary developers contained in the container to a developing device without mixing of the developers. In addition, the amount of the toner included in each developer is relatively large, and therefore the carrier tends to easily degrade, resulting in variation of image qualities when images are produced by the developing method over a long period of time. Further, when the weight of a silicone resin cover layer formed on the surface of particles of a carrier used for the developing method is increased to increase the electric resistance of the carrier, the charge imparting ability of the carrier deteriorates although the electric resistance thereof is increased, thereby deteriorating the image qualities (such as image reproducibility) and/or causing the background development problem.

The above-mentioned proposals have been made for a development operation using a color toner, and are not made for a development operation which uses a transparent toner to produce a glossy image portion while reducing the fixing energy and which involves a risk of causing the above-mentioned spent toner problem (i.e., a risk of deteriorating the charge imparting ability of the carrier).

For these reasons, the present inventors recognized that there is a need for an image forming method by which highly glossy images can be stably produced using a developer including a low temperature fixable transparent toner and a carrier without causing the hot offset problem and the high temperature preservability problem and without deteriorating the properties of the carrier used for development.

### SUMMARY

This patent specification describes a novel image forming method of producing at least one color toner image and a transparent toner image on a recording material. The image forming method uses a first developing device which develops an electrostatic latent image with a first developer including a color toner and a carrier including a core material and a cover layer located on the core material to form the color toner image, and a second developing device which develops an electrostatic latent image with a second developer including a transparent toner and the carrier or another carrier including a core material and a cover layer located on the core material to form the transparent toner image. The color toner image and the transparent toner image are transferred onto the recording material so as to be partially or entirely overlapped, and then the toner images are fixed to the recording material. The image forming method uses a trickle developing method, in which a supplementary developer including the transparent toner and the carrier is supplied to a developing device while excess of the developer in the developing device is discharged, at least for the second developing device. Further, the transparent toner includes a resin and a lubricant, and has a viscoelastic property such that a loss tangent (tan δ), which is defined as a ratio (G″/G′) of loss modulus (G″) thereof to storage modulus (G′) thereof, has a peak at a temperature of from 80° C. to 160° C. and the peak has a height of not less than 3.

This patent specification describes a novel two-component developer including a carrier and a transparent toner including a resin and a lubricant, and has the above-mentioned viscoelastic property. The transparent toner is preferably used for the above-mentioned image forming method.

This patent specification describes a novel image forming apparatus including an image bearing member; a first developing device to develop an electrostatic latent image on the image bearing member with a first developer including a color toner and a carrier including a core material and a cover layer located on the core material to form a color toner image on the image bearing member; a second developing device to develop an electrostatic latent image on the image bearing member or another image bearing member with the above-mentioned two-component developer to form a transparent toner image on the image bearing member; a developer supplying device to feed a supplementary developer including the transparent toner and the carrier to the second developing device; a transferring device to transfer the color toner image and the transparent toner image onto a recording material so as to be partially or entirely overlapped; and a fixing device to fix the toner images on the recording material. The developer supplying device has a container containing the supplementary developer and capable of changing the shape thereof, and a pump to feed the supplementary developer to the second developing device. The second developing device discharges excess of the developer therein upon receipt of the supplementary developer from the developer supplying device.

This patent specification describes a novel process cartridge including at least an image bearing member to bear an electrostatic latent image, and a developing device including the above-mentioned two-component developer to develop the electrostatic latent image with the developer. The developing device receives a supplementary developer including the transparent toner and the carrier from outside while discharging excess of the developer in the developing device. The image bearing member and the developing device are integrated into a single unit so as to be detachably attachable to an image forming apparatus.

### BRIEF DESCRIPTION OF THE DRAWINGS

A more complete appreciation of aspects of the invention and many of the attendant advantage thereof will be readily obtained as the same become better understood by reference to the following detailed description when considered in connection with the accompanying drawings, wherein:

FIG. 1 is a schematic view illustrating a color image forming apparatus as one example of the image forming apparatus of the present invention;

FIG. 2 is a schematic view illustrating a developer supplying device and a developing device for use in the image forming apparatus of the present invention;

FIG. 3 is a schematic view illustrating another developer supplying device for use in the image forming apparatus of the present invention;

FIGS. 4A-4C are schematic views illustrating a nozzle of the developer supplying device illustrated in FIG. 3;

FIG. 5 is a schematic view illustrating a screw pump of the developer supplying device illustrated in FIG. 3;

FIG. 6 is a schematic perspective view illustrating a developer container of the developer supplying device, which is filled with a supplementary developer;

FIG. 7 is a schematic view illustrating the developer container, which is shrunk because the supplementary developer therein is fed to the developing device; and

FIG. 8 is a schematic view illustrating an example of the process cartridge of the present invention.

### DESCRIPTION OF THE PREFERRED EMBODIMENTS

The present invention will be described in detail.

When a low temperature fixable transparent toner is used, not only a fixing energy saving effect but also a glossiness enhancing effect in that the glossiness of a portion of an image having a transparent toner image thereon is enhanced because the transparent toner image is fully melted in the fixing process. Imparting glossiness to an image is a main purpose of a development operation using a transparent toner, and is the most important function of the transparent toner. However, when the low temperature fixability of toner is enhanced, the high temperature preservability of the toner tends to deteriorate, and the spent toner problem in that toner adheres to the surface of a carrier when the toner and the carrier are agitated in a developing device, thereby deteriorating the charging ability of the carrier tends to be caused. Therefore, the problem to be solved is to develop a transparent toner having a good combination of low temperature fixability, high temperature fixability and resistance to the spent toner problem.

As a result of the present inventors' investigation, it is discovered that the problem can be solved by an image forming method including:

developing an electrostatic latent image on an image bearing member with at least a developing device using a developer including a transparent toner and a carrier, wherein the transparent toner includes a resin and a lubricant, and has a viscoelastic property such that a loss tangent (tan δ), which is defined as a ratio (G″/G′) of loss modulus (G″) thereof to storage modulus (G′) thereof, has a peak of not less than 3 at a temperature of from 80° C. to 160° C.; and

supplying a supplementary developer including the transparent toner and the carrier to the developing device while discharging excess of the developer in the developing device.

By using this method, glossy images can be stably produced over a long period of time with low fixing energy while preventing occurrence of the above-mentioned problems such as the high temperature preservation problem, the hot offset problem, the background development problem, and the carrier degrading problem.

The transparent toner for use in the image forming method of the present invention includes a resin having a viscoelastic property such that a loss tangent (tan δ), which is defined as a ratio (G″/G′) of loss modulus (G″) thereof to storage modulus (G′) thereof, has a peak at a temperature of from 80° C. to 160° C. and the peak has a height of not less than 3. The resin is preferably a polyester resin.

In order that the transparent toner produces an image having a high glossiness while being fixed at a relatively low temperature, the toner preferably has a property such that the storage modulus (G′) thereof suddenly decreases sharply from a certain temperature (i.e., a melting temperature at which the resin constituting the transparent toner changes its state from a glass state to a liquid state via a rubber state). When the transparent toner has such a property, the toner can easily enter into recessed portions of a rough paper serving as a recording material and microscopic recessed portions of a color toner image (such as yellow, magenta and cyan images), on which the transparent toner image is to be formed, while having good ductility. In this regard, it is preferable for the toner in view of hot offset resistance that the storage modulus (G′) thereof hardly decreases (i.e., does not sharply decrease) after the resin has a certain viscosity. Further, it is preferable for the toner that the loss modulus (G″) thereof sharply decreases from the temperature even though the decreasing rate of the loss modulus (G″) is not sharper than that of the storage modulus (G′).

Unless the storage modulus (G′) sharply decreases from a certain temperature and the compliance with an external sinusoidal stress has a maximal value in a certain temperature range (i.e., the resin is not sensitive to an external sinusoidal stimulation, namely there is no maximal output loss in the imaginary part of the calculating formula used for determining the viscoelastic property), there is no peak in the loss tangent curve.

Only a toner having such a property as mentioned above can have a peak in the loss tangent curve. The peak is preferably observed at a temperature of from 80° C. to 160° C., and the peak preferably has a height of not less than 3. When a peak is observed at a temperature lower than 80° C., the storage modulus (G′) tends to decrease when the toner is preserved at a relatively high temperature, resulting in deterioration of the high temperature preservability of the toner (i.e., the toner aggregates when being preserved at a high temperature). When a peak is observed at a temperature higher than 160° C., the low temperature fixability of the toner tends to deteriorate.

In addition, when the height of the peak of the loss tangent (tan δ) curve of the toner is less than 3, the decreasing rate of the storage modulus (G′) thereof is relatively low compared to the decreasing rate of the loss modulus (G″) thereof, and therefore a good combination of low temperature fixability and hot offset resistance cannot be imparted to the toner.

When the loss tangent (tan δ) of the transparent toner is too high, the toner tends to cause the hot offset problem, and in addition a toner preparation apparatus for preparing the toner tends to be contaminated with the toner. Therefore, the loss tangent is preferably not greater than 50, and more preferably not greater than 30.

The loss tangent (tan δ) of a transparent toner (and a resin) is measured with a viscoelasticity measuring method. For example, the following method can be used.

(1) 0.8 grams of a sample (toner or resin) is pelletized using a die having a diameter of 20 mm upon application of pressure of 30 MPa; and
(2) the loss modulus (G″), the storage modulus (G′) and the loss tangent (tan δ) of the sample are measured using an instrument, ADVANCED RHEOMETRIC EXPANSION SYSTEM from TA with a parallel cone having a diameter of 20 mm.

The measuring conditions are as follows.

Frequency: 1.0 Hz

Temperature rising speed: 2.0° C./min

Strain: 0.1% (automatic strain control, allowable minimum stress: 1.0 g/cm, allowable maximum stress: 500 g/cm, maximum applied strain: 200%, strain adjustment: 200%)

In this regard, the data of the loss tangent obtained when the storage modulus (G′) becomes not greater than 10 are excluded.

Thermoplastic resins are preferably used for the transparent toner. Among thermoplastic resins, resins having a (Mw/Mn) ratio (polydispersity) of the weight average molecular weight (Mw) thereof to the number average molecular weight (Mn) of not greater than 6 are preferably used. Particularly, it is not preferable to use resins, which are prepared by using a large amount of crosslinkable monomer and which have a broad molecular weight distribution because of having a number of branched chains, for the transparent toner because glossy images cannot be produced.

In order to produce glossy images, linear polyester resins or slightly crosslinked polyester resins are preferably used for the transparent toner. The (Mw/Mn) ratio of such polyester resins is preferably not greater than 6, and more preferably not greater than 5. When the (Mw/Mn) ratio is greater than 6, images produced by the toner tend to have low glossiness. It is possible to use two or more kinds of linear polyester resins and/or slightly crosslinked polyester resins for the transparent toner.

In the present application, the number average molecular weight (Mn) and the weight average molecular weight (Mw) of resins for use in the transparent toner are measured with a combination of an instrument using gel permeation chromatography (GPC), GPC-150C (Waters Corp.), and columns KF801-807 from Showa Denko K.K. The measuring method is as follows.

(1) The columns are stabilized at 40° C. in a heat chamber;
(2) Tetrahydrofuran is fed to the columns at a flow rate of 1 ml/min;
(3) 0.05 g of a sample (resin) is dissolved in 5 g of tetrahydrofuran and the solution is filtered using a filter (such as filters having pore size of 0.45 μm (e.g., CHOROMATODISK from Kurabo Industries Ltd.), and then diluted to prepare a THF solution of the resin having a concentration of from 0.05 to 0.6% by weight;
(4) 50 to 200 μl of the solution is fed to the columns to measure the weight average molecular weight (Mw) and the number average molecular weight (Mn) of the resin using a working curve showing relation between counts and amounts and prepared by using monodisperse polystyrenes.

The monodisperse polystyrenes are available from Pressure Chemical Co., or Tosoh Corp., and at least ten monodisperse polystyrenes having different molecular weights (such as 6×10², 2.1×10³, 4×10³, 1.75×10⁴, 5.1×10⁴, 1.1×10⁵, 3.9×10⁵, 8.6×10⁵, 2×10⁶, and 4.48×10⁶) are preferably used for preparing a working curve. In measurements, it is preferable to use a RI (refractive index) detector as the detector.

A transparent toner image consisting of the transparent toner is preferably formed as an outermost layer of an overlaid toner image formed on the surface of a recording material because the glossiness of the image formed on the recording material can be enhanced.

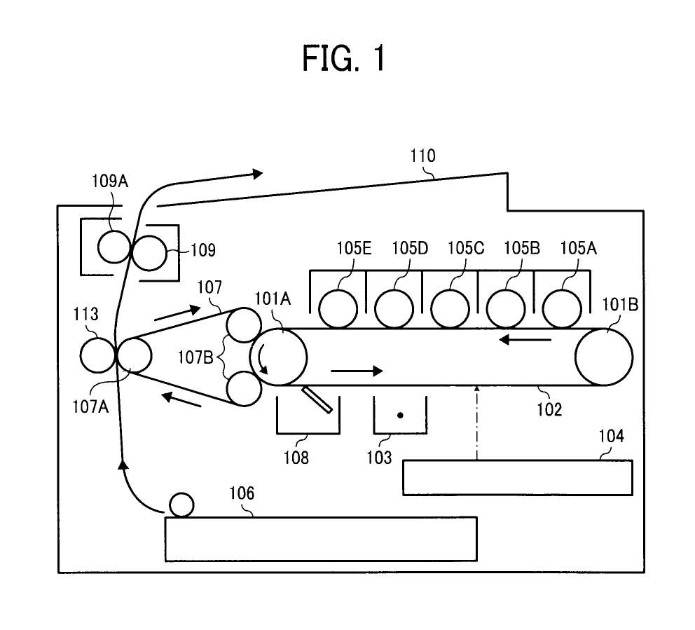

The method for forming a transparent image as an outermost layer is not particularly limited. For example, an image forming method in which a color toner image and a transparent toner image are separately formed on an image bearing member or plural image bearing members using respective developing devices, and the color toner image and the transparent toner image are transferred onto a recording material optionally via an intermediate transfer medium so that the transparent toner image is preferably located on the color toner image on the recording material, followed by fixation of the toner images, can be used. Specifically, in a full color image forming apparatus, five developing devices for forming yellow, magenta, cyan, black and transparent toner images are typically used as illustrated in FIG. 1.

In the image forming method of the present invention, it is possible to perform only one fixing operation, but two or more fixing operations may be performed to produce highly glossy images. For example, an image forming method in which initially an image forming operation (charging process, irradiating process, developing process, transferring process and fixing process) is performed using one or more color toners and the transparent toner to prepare a glossier image portion (first image portion) on a recording material, and then a second image portion (i.e., normally glossy image portion) is formed on the recording material by performing a second image forming operation (charging process, irradiating process, developing process, transferring process and fixing process) using one or more color toners. In this method, the glossier image portion is subjected to the fixing process twice. Therefore, the first image portion has a higher glossiness than the second image portion.

When the fixing process is performed twice, a sufficient amount of heat can be applied to the first image portion which bears a relatively large amount of toner particles consisting of a color toner image and a transparent toner image compared to the second image portion, thereby smoothing the surface of the first image portion, resulting in impartment of a higher glossiness to the first image portion. In addition, since the second image portion is not fixed at a low fixing temperature (i.e., the second image portion is also fixed at the same temperature), a sufficient amount of heat is applied to the image, and thereby the second image portion can be firmly fixed to a recording material.

Since a transparent toner image is formed on a color toner image, the transparent toner image is directly contacted with a fixing member, and therefore the transparent toner preferably has better releasability, hot offset resistance and glossing property than color toners.

The glossing ability of a color toner is determined depending on the applications of the produced color image. When the color toner image formed by a color toner is required to have a high glossiness, it is preferable to use a resin having a small Mw/Mn ratio for the color toner. By contrast, when the color toner image is required to have a low glossiness, it is preferable to use a resin having a large Mw/Mn ratio for the color toner.

However, in a case where the color toner image (normally glossy image portion) has a relatively high glossiness, the transparent toner image formed on the color toner image also has a high glossiness, but the difference in glossiness between the first image portion and the second image portion decreases. By contrast, in a case where the color toner image has a relatively low glossiness, the difference in glossiness between the first image portion and the second image portion can be increased, but the glossiness of the first image portion (glossier portion) is relatively low compared to that in the above-mentioned first case.

In the above-mentioned second case, the reason why the glossiness of the image is relatively low is considered to be that light scattering is caused at the interface between the transparent toner image and the color toner image due to the viscoelastic restoring force of the resin constituting the color toner. Therefore, in order to produce a highly glossy image portion in the above-mentioned second case, it is preferable to increase the thickness of the transparent toner image formed on the color toner image. The thickness of the fixed transparent toner image is preferably from 1 μm to 15 μm. When the fixed transparent toner image has a thickness of less than 1 μm, it is hard to impart a high glossiness to a color image. By contrast, when the fixed transparent toner image has a thickness of greater than 15 μm, the transparent toner image is insufficiently fixed (i.e., the fixed transparent toner has an insufficient mechanical strength), and in addition the transparent toner image has low transparency, resulting in deterioration of the color reproducibility of the resultant color image. The thickness of a fixed toner image formed on a recording material can be determined by cutting a portion of the recording material bearing the toner image with a microtome, and visually observing the cross section of the toner image using a microscope.

A crystalline polyester resin can be used for the transparent toner as long as the transparent toner has the above-mentioned viscoelastic property.

When a crystalline polyester resin is used in combination with a noncrystalline polyester resin, the resultant toner has a good low temperature fixability, and a high glossiness can be imparted to an image even when the image is fixed at a relatively low fixing temperature. The added amount of a crystalline polyester resin is generally from 1 to 25 parts by weight, and preferably from 1 to 15 parts by weight, per 100 parts by weight of a noncrystalline polyester resin. When the added amount of a crystalline polyester resin is too high, a film of the crystalline polyester resin tends to be formed on the surface of an image bearing member such as a photoreceptor, resulting in deterioration of image qualities, and in addition the high temperature preservability of the toner tends to deteriorate. Further, the transparency of the transparent toner image tends to deteriorate. When a fatty acid amide based lubricant is included in the transparent toner together with a crystalline polyester resin, the lubricant imparts good lubricating property to the toner while accelerating crystallization of the polyester resin, thereby improving the high temperature preservability of the toner.

The transparent toner includes a lubricant. Since a transparent toner image takes the outermost position of overlaid plural toner images, the transparent toner image preferably has a good hot offset resistance, and therefore it is preferable to include a lubricant in the transparent toner so that the transparent toner image has good releasability from a fixing member. Specific examples of the lubricant include aliphatic hydrocarbon-based lubricants such as liquid paraffins, microcrystalline waxes, natural paraffins, synthesized paraffins, and polyolefin waxes, and partially-oxidized versions, fluorides and chlorides of these materials; animal-derived lubricants such as beef tallow and fish oils; plant-derived lubricants such as palm oil, soybean oil, canola oil, rice bran wax and carnauba wax; higher aliphatic alcohol/higher fatty acid based lubricants such as montan waxes; metal soap lubricants such as fatty amides, fatty bisamides, zinc stearate, calcium stearate, magnesium stearate, aluminum stearate, inc oleate, zinc palmitate, magnesium palmitate, zinc myristate, zinc laurate and zinc behenate; fatty acid esters, polyvinylidene fluoride, etc., but are not limited thereto. These materials can be used alone or in combination.

When such a lubricant is included inside transparent toner particles, the added amount thereof is from 0.1 to 15 parts by weight, and preferably from 1 to 7 parts by weight, per 100 parts by weight of the resin used for the transparent toner. When a lubricant is included inside transparent toner particles, good hot offset resistance can be imparted to the transparent toner while imparting a good combination of mechanical strength and abrasion resistance to fixed transparent toner images. Therefore, even when the transparent toner is used for high speed image forming apparatuses, a transparent toner image can be fixed at a relatively low fixing temperature. When the added amount of a lubricant is smaller than 0.1 parts by weight, the hot offset resistance cannot be satisfactorily enhanced. By contrast, when the added amount is large than 10 parts by weight, the spent toner problem tends to be caused, resulting in deterioration of image qualities. When a lubricant is present on a surface portion of toner particles (for example, when toner particles are prepared by pulverizing a kneaded toner component mixture including a lubricant, the lubricant tends to be present on the surface of the resultant toner particles), the weight ratio (L/R) of the lubricant (L) to the resin (R) used for the transparent toner is from 0.001/100 to 1/100, and preferably from 0.01/100 to 0.3/100. It is preferable that a lubricant is present on a surface of toner particles, because the lubricant is directly contacted with the surface of an image bearing member, thereby forming a thin layer of the lubricant thereon, and therefore a toner image can be easily released from the surface of the image bearing member. In addition, adhesion of a toner image to the surface of the image bearing member can also be prevented.

Each of the transparent toner and color toners can include a charge controlling agent. Specific examples thereof include Nigrosine dyes and fatty acid metal salts, and their derivatives; onium salts such as phosphonium salts, and their lake pigments; triphenyl methane dyes and their lake pigments; higher fatty acids and metal salts thereof; diorganotin oxides such as dibutyltin oxide, dioctyltin oxide, and dicyclohexyltin oxide; diorganotin borates such as dibutyltin borate, dioctyltin borate, and dicyclohexyltin borate; organic metal complexes, chelate compounds, monoazo metal complexes, acetylacetone metal complexes, metal complexes of aromatic dicarboxylic acids, quaternary ammonium salts, aromatic hydroxyl carboxylic acids and their metal salts, aromatic mono- or poly-caboxylic acids and their metal salts, anhydrides and esters, phenol derivatives such as bisphenol, etc. These materials can be used alone or in combination.

When a charge controlling agent is included inside the toners, the added amount of the charge controlling agent is from 0.1 to 10 parts by weight per 100 parts by weight of the binder resin included in the toners. In this regard, colorless or white charge controlling agents are preferably used for the transparent toner.

The transparent toner and color toners can include an external additive. Specific examples of such an external additive include abrasives such as silica, powders of TEFLON (registered trademark), powders of polyvinylidene fluoride, powders of cerium oxide, powders of silicone carbide, and powders of strontium titanate; fluidity imparting agents such as powders of titanium oxide, and powders of aluminum oxide; aggregation inhibitors; resin powders; electroconductive agents such as powders of zinc oxide, antimony oxide, and tin oxide; and developability improving agents such as white particulate materials and black particulate materials having charges with opposite polarities. These external additives can be used alone or in combination. By using such an external additive for a toner, the toner has good resistance to stresses caused in a developing device.

When a two-component developing method is used, a developer including a magnetic carrier and a toner such as a transparent toner and a color toner is used. Specific examples of the carrier include spinel-form ferrites such as magnetite and γ-iron oxide, spinel-form ferrites including one or more metal other than iron such as Mn, Ni, Mg and Cu, magnetoplumbite-form ferrites such as barium ferrite, and particulate metals (Fe or metal alloys) having an oxide layer on the surface thereof. The shape of the particulate carrier is not particularly limited, and for example, granular, spherical and needle-form carriers can be used. When a carrier having a relatively high magnetization intensity is needed, ferromagnetic particulate materials (such as iron) are preferably used. In view of chemical stability, spinel-form ferrites (such as magnetite and γ-iron oxide), and magnetoplumbite-form ferrites (such as barium ferrite) are preferably used.

Specific examples of the marketed carrier materials include MFL-35S, and MFL-35HL, which are from Powdertech Co., Ltd., DFC-400M, DFC-410M, and SM-350NV, which are from Dowa IP Creation Co., Ltd., etc.

By using a proper ferromagnetic particulate material for a resin carrier while controlling the added amount thereof, a resin carrier having a desired magnetization intensity of from 30 to 150 emu/g (30 to 150 A·m²/kg) at 1000 Oe (7.96×10⁴ A/m) can be provided. Such resin carriers can be prepared, for example, by a method in which a particulate magnetic material and an insulating resin are heated so that the resin is melted, the mixture is then kneaded, and the kneaded mixture is sprayed using a spray drier, or a method in which a monomer or a prepolymer dispersed in an aqueous medium in the presence of a particulate magnetic material is reacted and crosslinked to form a condensation polymer (binder resin) in which the particulate magnetic material is dispersed.

It is possible to control the charging ability of a magnetic carrier by adhering a positively or negatively chargeable particulate material or electroconductive material on the surface of the magnetic carrier or by coating the surface of the magnetic carrier with a resin. Specific examples of the resin material used for the coating liquid include silicone resins, acrylic resins, epoxy resins, fluorine-containing resins, etc. The coating liquid can include a positively or negatively chargeable particulate material or electroconductive material. Among these resin materials, silicone resins and acrylic resins can be preferably used.

The content of a carrier in the developer contained in the developing device of the image forming apparatus of the present invention is preferably from 85% to 98% by weight. When the content is less than 85% by weight, a toner scattering problem in that the toner in the developer is scattered from a developing device, resulting in formation of an abnormal image tends to be caused. By contrast, when the content is greater than 98% by weight, the charge quantity of the toner is excessively increased or the amount of toner fed to a developing device is decreased, resulting in decrease of image density or formation of abnormal images.

In the present invention, the particle size of toner is determined from a number basis particle diameter distribution and a volume basis particle diameter distribution of the toner obtained by using an instrument, COULTER MULTISIZER III from Beckman Coulter Inc. The procedure is as follows:

(1) a sample (toner) is mixed with an electrolyte to which a surfactant is added;
(2) the mixture is dispersed for 1 minute using an ultrasonic dispersing machine; and
(3) the number basis particle diameter distribution and the volume basis particle diameter distribution of 50,000 particles of the sample (toner) are measured, followed by averaging.

The average particle diameter is preferably from 2 μm to 10 μm.

The method for preparing the transparent toner and the color toners is not particularly limited. For example, the following method can be used.

(1) toner components such as a binder resin (fixable resin), a lubricant, an optional colorant, and an optional fixable resin, in which a charge controlling agent and an additive are dispersed, are mixed using a mixer such as HENSCHEL MIXER and SUPER MIXER;
(2) the mixture is heated so as to be melted and kneaded with a kneader such as heat rolls, kneaders and extruders so that the toner components are satisfactorily mixed; and
(3) after the kneaded mixture is cooled, the mixture is crushed and pulverized, followed by classification to prepare a toner.

In the pulverization process, a jet mill in which a crushed kneaded mixture is fed into high speed airflow so as to be collided against a collision plate to be pulverized, an inter-particle collision method in which a crushed kneaded mixture is collided against each other to be pulverized, a mechanical pulverization method in which a crushed kneaded mixture is fed into a gap between a rotor rotated at a high speed and a stator to be pulverized, etc., can be used.

In addition, the following solution suspension method can also be used for preparing the toners.

(1) toner components (such as the above-mentioned components) and an optional reactive resin are dissolved or dispersed in an organic solvent to prepare an oil phase liquid;
(2) the oil phase liquid is dispersed in an aqueous phase liquid;
(3) after optionally reacting the reactive resin (such as polymer chain growth reaction of a polyester prepolymer), the organic solvent is removed from the dispersed oil phase liquid to prepare a dispersion of toner particles; and
(4) after filtering the toner particle dispersion, the toner particles are washed, and then dried, resulting in formation of a mother toner (dry toner particles).

Next, the image forming apparatus of the present invention will be described.

FIG. 1 illustrates an electrophotographic image forming apparatus, which is an example of the image forming apparatus of the present invention.

Referring to FIG. 1, the image forming apparatus includes a photoreceptor belt 102, which is rotated by a driving roller 101A and a driven roller 101B while tightly stretched thereby. In addition, the image forming apparatus includes a charger 103 to charge the surface of the photoreceptor belt 102, an image writing unit 104 to irradiate the charged photoreceptor belt with a laser beam to form an electrostatic latent image on the photoreceptor belt, developing units 105A-105D which contain yellow, magenta, cyan and black toners to develop electrostatic latent images with the toners to prepare color toner images on the surface of the photoreceptor belt, and a developing unit 105E which contains a transparent toner to form a transparent toner image on the photoreceptor belt. The image forming apparatus further includes a recording material sheet cassette 106 to contain and feed sheets of a receiving material such as paper sheets, an intermediate transfer belt 107, to which the toner images formed on the photoreceptor belt 102 are transferred by a secondary transfer roller 113 and which are rotated by a driving roller 107A, and driven rollers 107B and 107B, a cleaner 108 to clean the surface of the photoreceptor belt 102 after the toner images thereon are transferred, a fixing device including a fixing roller 109 and a pressure roller 109A to fix the toner image on the receiving material, and a copy tray 110 on which a copy (a receiving material sheet bearing a fixed toner image thereon) is discharged.

This color image forming apparatus uses the intermediate transfer belt 107, which is a flexible belt and which is rotated clockwise by the driving roller 107A and a pair of driven rollers 107B while tightly stretched thereby. A portion of the intermediate transfer belt 107 located between the pair of driven rollers 107B and 107B is contacted with the outer surface of a portion of the photoreceptor belt 102 contacted with the driving roller 101A.

When a full color image is formed in the color image forming apparatus, yellow, magenta, cyan and black toner images formed on the photoreceptor belt 102 are sequentially transferred onto the intermediate transfer belt 107 so as to be overlaid, thereby forming a combined color toner image on the intermediate transfer belt. The combined color toner image is transferred onto a recording material sheet, which is fed from the recording material sheet cassette 106, by the secondary transfer roller 113. The recording material sheet bearing the combined color toner image thereon is fed to a fixing nip between the fixing roller 109 and the pressure roller 109A so that the toner image is fixed thereon by the rollers. The recording material sheet bearing the fixed toner image thereon (i.e., copy) is discharged on the copy tray 110.

After the developing devices 105A-105E perform the developing operations using the respective developers contained therein, the concentrations of toners contained in the developers decrease. When decrease of the toner concentration is detected by a toner concentration sensor (not shown), developer supplying devices connected with the respective developing devices 105A-105E are operated and developers including the respective toners are supplied to the developing devices to increase the toner concentrations.

In the image forming apparatus illustrated in FIG. 1, color toner images formed on the photoreceptor 102 are overlaid on the intermediate transfer belt 107. However, the image forming apparatus of the present invention is not limited thereto. For example, a direct-transfer type image forming apparatus in which color toner images formed on one or more photoreceptors are directly transferred onto a recording material can also be used as the image forming apparatus of the present invention.

Next, the configuration of the developing device and peripheral devices will be described.

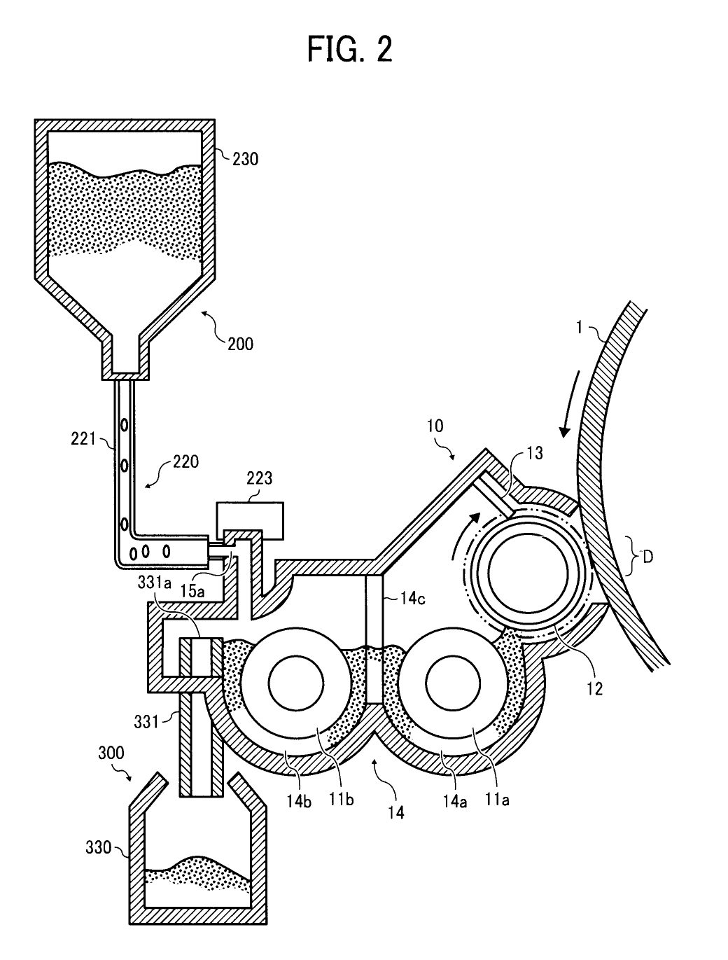

FIG. 2 illustrates a developing device and a developer supplying device provided in the image forming apparatus. Referring to FIG. 2, a developer supplying device 200 to supply a supplementary developer including a fresh toner and a fresh carrier to the corresponding developing device 10 is provided above the developing device, and a developer discharging device 300 to discharge excess of the developer in the developing device is provided below the developing device.

By using this method, greater part of the degraded carrier in the developing device 10 is discharged by the developer discharging device 300. In this example, the toner and the carrier used for the developer in the developer containing chamber 14 are used for the supplementary developer, and therefore the carrier (fresh carrier) is supplied to the developing device from the developer supplying device when the toner is supplied to the developing device from the developer supplying device. Therefore, even when the developer in the developing device is used over a long period of time, the charging property of the developer in the developing device can be stabilized.

The developing device 10 can have a configuration such that the developer passing a developing region D formed by an image bearing member (such as a photoreceptor) 1 and a developing roller 12 is returned to a developer supplying passage or a configuration such that the developer passing the developing region D is returned to a developer collection passage, which is different from the developer supplying passage. The developer fed to the developer collection passage is fed into the developer supplying passage or mixed with the developer fed through the developer supplying passage without fed to the developing region D so that the mixture is fed through again the developer supplying passage.

The developer supplying device 200 includes a developer container 230 to contain a supplementary two-component developer, and a developer feeder 220 to feed the supplementary developer to the developer containing chamber 14. The developer feeder 220 connects the developer container 230 with the developer containing chamber 14.

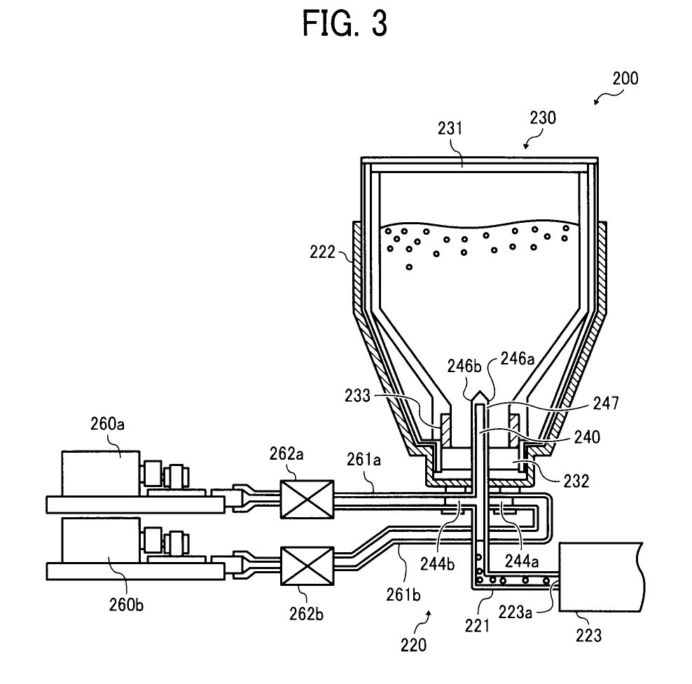

The configuration of the developer supplying device 200 is described later in detail by reference to FIG. 3.

The developer discharging device 300 includes a collection container 330 to contain excess of the developer, i.e., the overflow of the developer from the second chamber 14b of the developer containing chamber 14, and a feeding pipe 331 through which the excess of the developer is fed from the developer containing chamber 14 to the collection container 330. The feeding pipe 331 has an upper opening 331a which has a predetermined height above the bottom of the developer containing chamber 14 so that the overflow of the developer from the developer containing chamber is fed to the collection container 330 through the feeding pipe 331.

The configuration of the developer discharging device 300 is not limited to the configuration described above. For example, the developer discharging device 300 can have a configuration such that an opening is provided on a predetermined point of the housing of the developer containing chamber 14, and part of the developer in the developer containing chamber 14 is fed to the collection container 330 by a feeding member such as a screw.

In addition, the developer discharging device 300 can have a configuration such that a screw is provided at an edge or inside of the feeding pipe 331 to feed the overflow of the developer from the developer containing chamber 14 to the collection container 330.

The supplementary developer contained in the developer container 230 includes a color toner or a transparent toner, which is the above-mentioned toner, and the above-mentioned magnetic carrier. The toner in the supplementary developer is the same as or different from the toner contained in the developer containing chamber 14. In addition, the carrier in the supplementary developer is the same as or different from the carrier contained in the developer containing chamber 14.

The supplementary developer including a toner and a carrier is fed from the developer container 230 to the developer containing chamber 14 of the developing device 10 of the image forming apparatus.

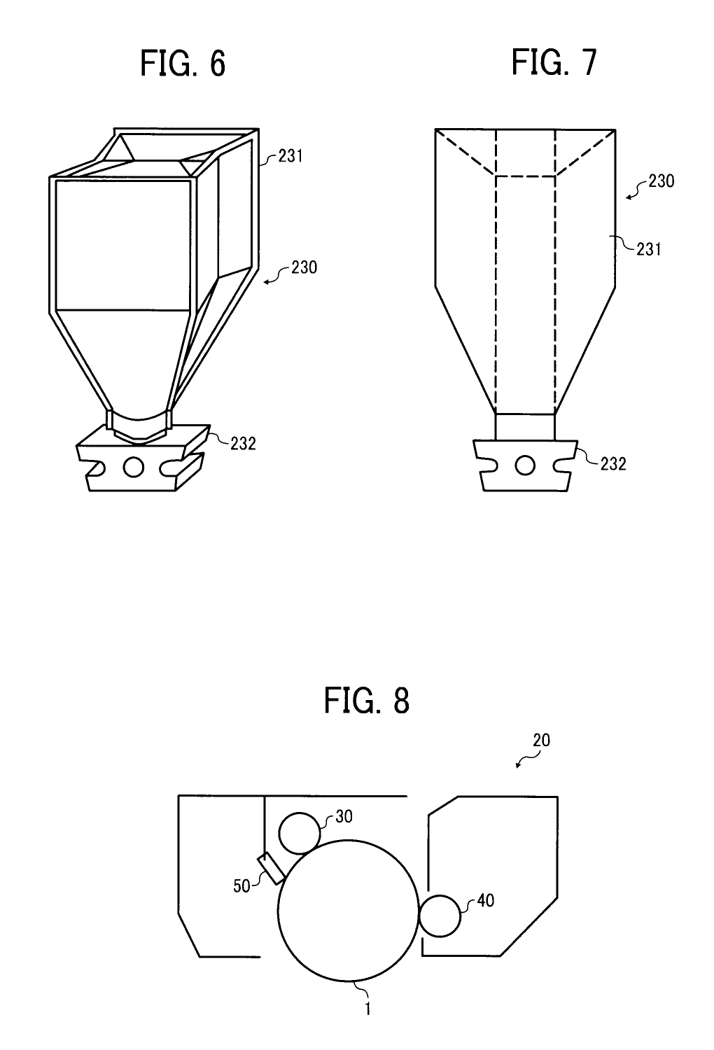

The developer supplying device 200 of the image forming apparatus 100 preferably has a deformable container 231 (illustrated in FIG. 6), which can easily change the shape thereof and which contains the supplementary developer thereon, and a screw pump 223 to suck the supplementary developer to feed the supplementary developer to the developing device 10.

In FIG. 2, reference numeral 14c denotes a partition formed between first and second chambers 14a and 14b, reference numerals 11a and 11b denote feeding screws to feed and circulate the developer in the developer containing chamber 14, and reference numeral 13 denotes a doctor blade to form a developer layer on the developing roller 12.

Next, the developer supplying device 200 will be described by reference to FIGS. 3-7.

FIG. 3 is a schematic view illustrating a developer supplying device for use in the image forming apparatus of the present invention. The developer supplying device 200 includes the developer container 230 including the deformable (shrinkable) container 231 containing the supplementary developer. As the supplementary developer is supplied from the deformable container 231 to the developer containing chamber 14, the container 231 shrinks due to decrease of the pressure therein.

The developer feeder 220 includes the screw pump 223 connected with a supply opening 15a provided on a predetermined position of the housing of the developing device 10, a nozzle 240 connected with the screw pump, and an air supplier connected with the nozzle 240. The developer feeder 220 is driven so as to feed the supplementary developer from the developer container 230 to the developer containing chamber 14 upon receipt of a detection signal from a toner concentration sensor (not shown) provided on the developer containing chamber 14.

The screw pump 223 and the nozzle 240 are connected with a feed tube 221 serving as a developer feeding passage. The feed tube 221 is preferably made of a flexible material having a good toner resistance such as polyurethane rubbers, nitrile rubbers, and EPDM rubbers.

The developer supplying device 200 includes a holder 222 to support the developer container 230. The holder 222 is made of a rigid material such as resins.

The developer container 230 includes the deformable container 231, which is a bag made of a soft sheet material, and a mouthpiece 232 forming a toner discharging opening.

The material used for forming the deformable container 231 is not particularly limited, but materials having good dimensional stability are preferably used. Specific examples of such materials include resins such as polyester resins, polyethylene resins, polypropylene resins, polystyrene resins, polyvinyl chloride resins, acrylic resins, polycarbonate resins, ABS resins, polyacetal resins, etc.

A seal member 233 made of a material such as sponges and rubbers and having a cross-shaped cutting is provided on the mouthpiece 232. By inserting the nozzle 240 of the developer feeder 220 into the cross-shaped cutting, the developer container 230 is fixedly connected with the developer feeder 220.

In this example, the developer container 230 is set such that the mouthpiece 232 is located at the bottom of the developer container 230 as illustrated in FIG. 3, but the setting position of the developer container is not limited thereto. The developer container 230 may be horizontally or obliquely set.

The developer container 230 is replaced with a new container when the developer therein is exhausted. Since the container 230 has the above-mentioned configuration, the replacement operation can be easily performed while preventing leakage of the developer from the container when the container is replaced and the developer in the container is supplied to the developing device.

The size, shape, structure and constitutional material of the deformable container 231 are not particularly limited, and the factors are properly determined so that the container fulfills the purpose thereof.

The developer container 230 can be easily attached to or detached from the developer supplying device 200 of the image forming apparatus 100 while having a good combination of preservation property, transport property and handling property.

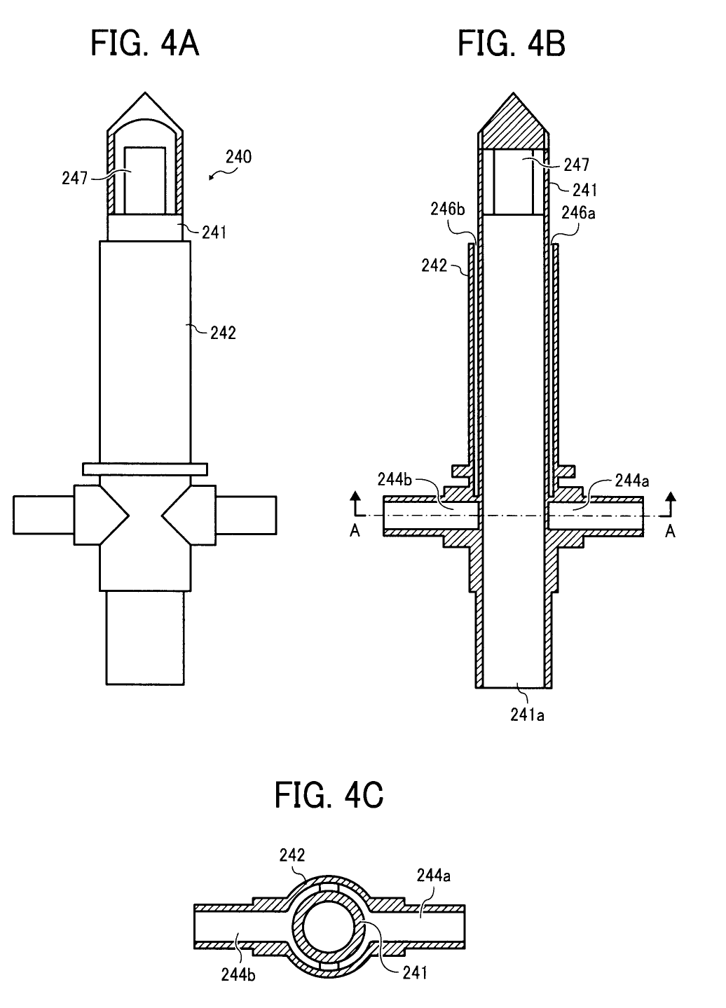

FIGS. 4A and 4B are a front view and a cross-sectional view illustrating the nozzle 240 of the developer feeder 220. In addition, FIG. 4C is a cross-sectional view of the nozzle 240 along a line A.

As illustrated in FIG. 4B, the nozzle 240 has a double tube structure, and has an inner tube 241, and an outer tube 242 containing the inner tube therein. The developer in the developer container 230 is fed through the inner tube 241, i.e., the inner tube serves as a developer feeding passage 241a. Specifically, the developer in the developer container 230 is drawn into the screw pump 223 through the developer feeding passage 241a by the sucking force of the pump.

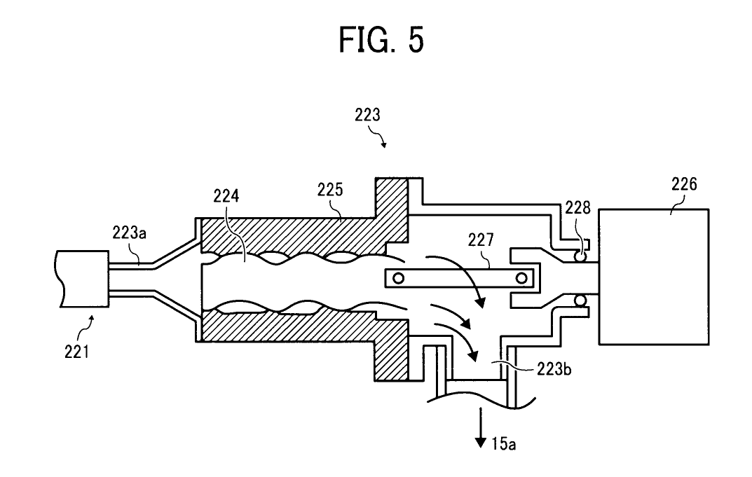

FIG. 5 is a cross-sectional view illustrating the screw pump 223. The screw pump 223 is called a uniaxial eccentric screw pump, and has a rotor 224 and a stator 225 therein. The rotor 224 has a circular spiral form and is made of a hard material. The rotor 224 is engaged with the inner surface of the stator 225. By contrast, the stator 225 is made of a soft material such as rubbers and has a cavity which has an oval form and is twisted spirally and with which the rotor 224 is engaged. In this regard, the pitch of the spiral stator 225 is twice the pitch of the spiral rotor 224. The rotor 224 is connected with a driving motor 226 via a universal joint 227 and a bearing 228 so as to be rotated.

The developer in the developer container 230 is fed through the developer feeding passage 241a of the nozzle 240 and the feed tube 221 and enters into a space of the screw pump 223 formed by the rotor 224 and the stator 225 through an entrance 223a of the screw pump. The developer is fed rightwards in FIG. 5 through the space by rotation and suction force of the rotor 224. The thus fed developer then falls from an exit 223b as illustrated by arrows in FIG. 5. The developer is then fed to the developer containing chamber 14 of the developing device 10 through the supply opening 15a.

The developer supplying device 220 has an air supplying device to supply air to the developer container 230.

Referring to FIG. 3, air flow passages 244a and 244b are connected with respective air pumps 260a and 260b, which serve as air suppliers, via respective air supply passages 261a and 261b.

As illustrated in FIG. 4B, the air flow passage is formed between the inner tube 241 and the outer tube 242, and is constituted of the independent two flow passages 244a and 244b, which have a semicircular form as illustrated in FIG. 4C.

Specific examples of the air pumps 260a and 260b include diaphragm air pumps. Air supplied by the air pumps 260a and 260b is supplied to the container 230 from air supplying openings 246a and 246b through the air flow passages 244a and 244b. As illustrated in FIG. 4B, the air supplying openings 246a and 246b are located below a developer exit 247 of the developer feeding passage 241a. Therefore, air supplied from the air supplying openings 246a and 246b is supplied to a portion of the developer located in the vicinity of the developer exit 247. Therefore, even when the developer in the developer container 230 is aggregated because of being left for a long period of time without being used, and thereby the developer exit 247 is clogged, the aggregated developer can be dissociated by the air supplied by the air pumps 260a and 260b. Accordingly, the developer can be satisfactorily fed from the container 230 to the developing device 10.

In addition, opening and closing valves 262a and 262b are provided on the air supply passages 261a and 261b. The valves are opened upon receipt of an ON signal from a controller (not shown) to flow air, and are closed upon receipt of an OFF signal from the controller to stop airflow.

The operation of the developer supplying device 220 will be described by reference to FIG. 3.

When the controller receives a signal from the developing device 10 such that the toner concentration is low, the controller orders the developer supplying device 220 to perform a developer supplying operation. Specifically, initially the air pumps 260a and 260b are operated to supply air to the container 230 while the driving motor 226 of the screw pump 223 is driven to suck the developer in the container 230.

When air is supplied to the developer container 230 by the air pumps 260a and 260b through the air supply passages 261a and 261b and the air flow passages 244a and 244b, the developer in the container 230 is agitated and fluidized because of containing air therein.

In addition, when air is supplied to the container 230, the internal pressure of the container 230 is increased so as to be higher than the atmospheric pressure. Therefore, the fluidized developer is moved toward the low pressure side. Specifically, the developer in the container 230 is discharged from the developer exit 247. In this example, since the developer is also sucked by the screw pump 223, the developer in the developer container 230 can be smoothly discharged from the developer exit 247.

The supplementary developer thus flown out of the developer container 230 is fed to the screw pump 223 via the developer feeding passage 241a and the feed tube 221. The supplementary developer is fed by the screw pump 223 and then falls from the pump exit 223b, thereby supplying the supplementary developer to the developing device 10 through the developer entrance 15a. After a predetermined amount of developer is supplied to the developing device 10 through the developer exit 223b by the screw pump 223, the controller stops the operations of the air pumps 260a and 260b, and the driving motor 226 while shutting the valves 262a and 262b. Thus, the developer supplying operation is completed. By shutting the valves 262a and 262b, occurrence of a problem in that the developer in the container 230 is reversely fed to the air pumps 260a and 260b through the air supply passages 244a and 244b can be prevented.

The amount of air fed by the air pumps is controlled so as to be smaller than the total amount of air and developer sucked by the screw pump 223. Therefore, as the amount of the developer in the container 230 decreases, the internal pressure of the container 230 is reduced. Since the deformable container 231 is made of a soft sheet material, the volume of the container 231 is reduced as the internal pressure thereof is reduced.

FIG. 6 is a schematic perspective view of the deformable container filled with the developer. FIG. 7 is a schematic front view of the deformable container, which is shrunk because the developer therein is discharged therefrom. In this regard, it is preferable for the container 231 to reduce its volume by 60% or more.

The supplementary developer contained in the deformable container 231 of the developer container 230 contains a toner and a carrier to be supplied to the developing device 10, wherein the content of the carrier in the developer is from 3% to 30% by weight based on the total weight of the developer. When the content of the carrier is lower than 3% by weight, the amount of the carrier supplied to the developing device is low, and the fresh carrier supplying effect is hardly produced. By contrast, when the content is higher than 30% by weight, the supplementary developer cannot be stably supplied to the developing device.

The image forming apparatus of the present invention is not limited to the above-mentioned image forming apparatus, and image forming apparatus having the same functions can also be used therefor.

FIG. 8 illustrates an example of the process cartridge of the present invention. Referring to FIG. 8, a process cartridge 20 includes the photoreceptor 1 serving as an image bearing member, a short-range brush charger 30 to charge the photoreceptor, a developing device 40 to develop an electrostatic latent image on the photoreceptor using the developer, which includes the toner and the carrier mentioned above for use in the present invention, to form a toner image on the photoreceptor, a cleaner 50 to clean the surface of the photoreceptor after transferring the toner image onto a recording material or an intermediate transfer medium, wherein these devices are integrated into a single unit. The process cartridge 20 can be detachably attachable to an image forming apparatus as a single unit.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### 1. Preparation of Polyester Resins for Use in Toners

### 1-1. Preparation of Polyester Resin A

The following components were fed into a 5-liter autoclave equipped with a distillation column so that the total weight of the components was 4,000 g.

Alcoholic components

| | |
|---|---|
| Polyoxypropylene(2.3)-2,2-bis(4-hydroxyphenyl)propane | 62% by mole |
| (BPA-PO) | |
| Ethylene glycol | 38% by mole |

Carboxylic acid components

| | |
|---|---|
| Adipic acid | 5% by mole |
| Terephthalic acid | 55% by mole |
| Isophthalic acid | 40% by mole |

In this regard, the molar ratio of the alcoholic components to the carboxylic acid components was 1/1.

The mixture was subjected to an esterification reaction at a temperature of from 170° C. to 260° C. under normal pressure without using a catalyst. Next, antimony trioxide in an amount of 400 ppm based on the total weight of the carboxylic acid components was added to the reaction product. The mixture was subjected to a polycondensation reaction at 250° C. under a reduced pressure of 3 torr (i.e., mmHg) while removing the glycols from the reaction system, resulting in preparation of a polyester resin A. The crosslinking reaction was continued until the reaction product had an agitation torque of 10 kg·cm (when measured at a revolution of 100 rpm). The reaction was stopped by cancelling decompression of the autoclave.

### 1-2 Preparation of Polyester Resin B

The procedure for preparation of the polyester resin A was repeated except that the alcoholic components and the carboxylic acid components were changed as follows.

Alcoholic components

| | |
|---|---|
| Polyoxypropylene(2.3)-2,2-bis(4-hydroxyphenyl)propane | 59% by mole |
| (BPA-PO) | |
| Ethylene glycol | 41% by mole |

Carboxylic acid components

| | |
|---|---|
| Adipic acid | 4% by mole |
| Terephthalic acid | 56% by mole |
| Isophthalic acid | 39% by mole |
| Trimellitic acid | 1% by mole |

Thus, a polyester resin B was prepared.

### 1-3 Preparation of Polyester Resin C

The procedure for preparation of the polyester resin A was repeated except that the alcoholic components and the carboxylic acid components were changed as follows.

Alcoholic components

| | |
|---|---|
| Polyoxypropylene(2.3)-2,2-bis(4-hydroxyphenyl)propane | 57% by mole |
| (BPA-PO) | |
| Ethylene glycol | 42% by mole |
| Glycerin | 1% by mole |

Carboxylic acid components

| | |
|---|---|
| Adipic acid | 6% by mole |
| Terephthalic acid | 55% by mole |
| Isophthalic acid | 39% by mole |

Thus, a polyester resin C was prepared.

### 1-4 Preparation of Polyester Resin D

The procedure for preparation of the polyester resin A was repeated except that the alcoholic components and the carboxylic acid components were changed as follows.

Alcoholic components

| | |
|---|---|
| Polyoxyethylene(2.3)-2,2-bis(4-hydroxyphenyl)propane | 55% by mole |
| (BPA-EO) | |
| Ethylene glycol | 40% by mole |
| Glycerin | 5% by mole |

Carboxylic acid components

| | |
|---|---|
| Adipic acid | 5% by mole |
| Terephthalic acid | 55% by mole |
| Isophthalic acid | 40% by mole |

Thus, a polyester resin D was prepared.

### 1-5 Preparation of Polyester Resin E

The procedure for preparation of the polyester resin A was repeated except that the alcoholic components and the carboxylic acid components were changed as follows.

Alcoholic components

| | |
|---|---|
| Polyoxyethylene(2.3)-2,2-bis(4-hydroxyphenyl)propane | 52% by mole |
| (BPA-EO) | |
| Ethylene glycol | 41% by mole |
| Glycerin | 7% by mole |

Carboxylic acid components

| | |
|---|---|
| Adipic acid | 4% by mole |
| Terephthalic acid | 55% by mole |
| Isophthalic acid | 41% by mole |

Thus, a polyester resin E was prepared.

The thus prepared polyester resins A-E were evaluated with respect to the following properties.

### (1) Softening Point

A flow tester, CFT-500D from Shimadzu Corp., was used to measure the softening point. Specifically, one gram of a resin was heated at a temperature rising speed of 6° C./min while applying a pressure of 1.96 MPa to the resin with a plunger so that the melted resin be extruded from a nozzle having a length of 1 mm and a diameter of 1 mm. A graph showing the relation between the temperature and the amount of decent of the plunger was prepared, and the softening point of the resin was determined as the temperature, at which the amount of decent of the plunger is ½ (i.e., half the resin (0.5 g of the resin) has been flown out of the nozzle).

### (2) Glass Transition Temperature (Tg)

A differential scanning calorimeter (DSC), DSC210 from Seiko instruments Inc., was used to measure the glass transition temperature. Specifically, 0.01 to 0.02 g of a resin was set on an aluminum pan, and the resin was heated to 200° C. in the differential scanning calorimeter. After the resin was cooled to 0° C. at a temperature falling speed of 10° C./m, the resin was heated again to 200° C. at a temperature rising speed of 10° C./m while recording a DSC curve. The glass transition temperature (Tg) was determined as the temperature, at which an extension of the base line of the DSC curve in a temperature range lower than the maximum endothermic peak crosses the rising portion of the maximum endothermic peak (i.e., a tangent to a curve of from a rise start point of the maximum endothermic peak to the top of the peak).

### (3) Acid Value (AV)

The acid value of a resin was measured by the method of JIS K0070 except that the solvent (i.e., a mixture solvent of ethanol and ether) was replaced with a mixture solvent of acetone and toluene in a volume ratio of 1/1.

### (4) Loss Tangent Peak Temperature (Tan δ Peak Temp.)

The loss tangent (tan δ) of a resin was measured with an instrument, ADVANCED RHEOMETRIC EXPANSION SYSTEM from TA. Specifically, the method is as follows.

1) 0.8 grams of a resin is pelletized using a die having a diameter of 20 mm upon application of pressure of 30 MPa thereto; and

2) the loss modulus (G″), the storage modulus (G′) and the loss tangent (tan δ) of the resin are measured using the instrument with a parallel cone having a diameter of 20 mm under the following conditions:

Frequency: 1.0 Hz

Temperature rising speed 2.0° C./min

Strain: 0.1% (automatic strain control, allowable minimum stress: 1.0 g/cm, allowable maximum stress: 500 g/cm, maximum applied strain: 200%, strain adjustment 200%)

GAP: The GAP was controlled by an operator such that “FORCE” in a PC screen falls in a range of from 0 to 100 gm after setting the sample.

The temperature (i.e., the loss tangent peak temperature), at which a loss tangent peak is observed, was determined. In this regard, the data of the loss tangent obtained when the storage modulus (G′) is not greater than 10 are excluded.

### (5) Molecular Weights (Mw and Mn)

The number average molecular weight (Mn) and the weight average molecular weight (Mw) of tetrahydrofuran-soluble components of a resin were measured with a combination of an instrument using gel permeation chromatography (GPC), GPC-150C (Waters Corp.) and columns KF801-807 from Showa Denko K.K. The measuring method is as follows.

1) The columns are stabilized at 40° C. in a heat chamber;

2) Tetrahydrofuran is fed to the columns at a flow rate of 1 ml/min;

3) 0.05 g of a sample (resin) is dissolved in 5 g of tetrahydrofuran and the solution is filtered using a filter (such as filters having pore size of 0.45 μm (e.g., CHOROMATODISK from Kurabo Industries Ltd.), and then diluted to prepare a THF solution of the resin having a solid content of from 0.05 to 0.6% by weight;

4) 50 to 200 μl of the solution is fed to the columns to measure the weight average molecular weight (Mw) and the number average molecular weight (Mn) of the resin using a working curve showing relation between counts and amounts and prepared by using monodisperse polystyrenes.

The monodisperse polystyrenes prepared by Tosoh Corp., and having different molecular weights, 6×10², 2.1×10³, 4×10³, 1.75×10⁴, 5.1×10⁴, 1.1×10⁵, 3.9×10⁵, 8.6×10⁵, 2×10⁶, and 4.48×10⁶, were used for preparing a working curve. In measurements, a RI (refractive index) detector was used as the detector.

The formula and properties of the polyester resins are shown in Table 1 below.

TABLE 1

| Formula and properties | | Polyester resins | | | | |
|---|---|---|---|---|---|---|
| of polyester resins | | A | B | C | D | E |
| Alcoholic | BPA-PO (% | 62 | 59 | 57 | — | — |
| com- | by mole) | | | | | |
| ponents | BPA-EO (% | — | — | — | 55 | 52 |
| | by mole) | | | | | |
| | Ethylene | 38 | 41 | 42 | 40 | 41 |
| | glycol (% by | | | | | |
| | mole) | | | | | |
| | Glycerin (% | — | — | 1 | 5 | 7 |
| | by mole) | | | | | |
| | Adipic acid | 5 | 4 | 6 | 5 | 4 |
| | (% by mole) | | | | | |
| | Terephthalic | 55 | 56 | 55 | 55 | 55 |
| | acid (% by | | | | | |
| | mole) | | | | | |
| | Isophthalic | 40 | 39 | 39 | 40 | 41 |
| | acid (% by | | | | | |
| | mole) | | | | | |
| | Trimellitic | — | 1 | — | — | — |
| | acid (% by | | | | | |
| | mole) | | | | | |
| | Softening | 110.4 | 122.1 | 119.3 | 120.8 | 120.1 |
| | point (° C.) | | | | | |
| | Tg (° C.) | 64.0 | 67.5 | 63.0 | 60.3 | 62.4 |
| | Tan δ peak | 143.0 | 156.5 | 136.5 | 137.0 | 111.0 |
| | temp. (° C.) | | | | | |
| | AV | 7.0 | 6.6 | 6.6 | 6.8 | 7.0 |
| | (mgKOH/g) | | | | | |
| | Mw | 15300 | 18700 | 19600 | 19840 | 20800 |
| | Mn | 3800 | 4900 | 3200 | 3580 | 3580 |

### 2. Preparation of Crystalline Polyester Resins

### 2-1. Preparation of Crystalline Polyester Resin A

The following components were fed into a 5-liter four-necked round-bottom flask equipped with a thermometer, an agitator, a condenser and a nitrogen feed pipe to be mixed.

Alcoholic components

| | |
|---|---|
| 1,4-Butanediol | 100% by mole |

Carboxylic acid components

| | |
|---|---|
| Fumaric acid | 90% by mole |
| Succinic acid | 5% by mole |
| Trimellitic acid | 5% by mole |

In this regard, the molar ratio of the alcoholic components to the carboxylic acid components was 1/1.

The total weight of these components was 4,000 g. In addition, 4 g of hydroquinone was added thereto.

After the flask was set in a mantle heater while a nitrogen gas was fed into the flask so that the atmosphere inside the flask was changed to inert atmosphere, the flask was heated to 160° C. to perform a reaction for 5 hours, followed by a further reaction for 1 hour at 200° C., and an additional reaction for 1 hour at 200° C. under a pressure of 8.3 kPa. Thus, a crystalline polyester resin A was prepared.

2-2 Preparation of Crystalline polyester Resin B

The procedure for preparation of the crystalline polyester resin A was repeated except that the alcoholic components and the carboxylic acid components were changed as follows.

Alcoholic components

| | |
|---|---|
| 1,5-Pentanediol | 90% by mole |
| 1,6-hexanediol | 10% by mole |

Carboxylic acid components

| | |
|---|---|
| Succinic acid | 5% by mole |
| Trimellitic acid | 5% by mole |
| Terephthalic acid | 90% by mole |

Thus, a crystalline polyester resin B was prepared.

The thus prepared crystalline polyester resins A and B were evaluated as follows.

### (1) Softening Point

The above-mentioned softening point measuring method was used.

The formula and property of the crystalline polyester resins are shown in Table 2 below.

TABLE 2

| Formula and property of | | Crystalline | Crystalline |
|---|---|---|---|
| crystalline polyester resins | | polyester A | polyester B |
| Alcoholic | 1,4-butanediol | 100 | — |
| components | (% by mole) | | |
| | 1,5-pentanediol | — | 90 |
| | (% by mole) | | |
| | 1,6-hexanediol | — | 10 |
| | (% by mole) | | |
| Carboxylic | Fumaric acid | 90 | — |
| acid | (% by mole) | | |
| components | Succinic acid | 5 | 5 |
| | (% by mole) | | |
| | Trimellitic | 5 | 5 |
| | acid (% by mole) | | |
| | Terephthalic | — | 90 |
| | acid (% by mole) | | |

| | | |
|---|---|---|
| Softening point (° C.) | 70 | 111 |

### 3. Preparation of Transparent Toners

### 3-1 Preparation of Transparent Toner 1

The following components were mixed using a HENSCHEL MIXER mixer (FM20B from NIPPON COKE & ENGINEERING CO., LTD.).

| | |
|---|---|
| Polyester resin A | 100 parts |
| Crystalline polyester resin A | 15 parts |
| Carnauba wax | 5 parts |
| (CARNAUBA WAX No. 1 from CERARICA | |
| NODA Co., Ltd.) | |
| Ethylenebisstearamide | 2 parts |
| (EB-P from Kao Corp.) | |

The toner component mixture was kneaded in a temperature range of from 100 to 130° C. using a twin-screw extruder, PCM-30 from Ikegai Corp. After the kneaded toner component mixture was cooled to room temperature, the solidified toner component mixture was crushed using a hammer mill so as to have a particle size of from 200 to 300 μm. The crushed toner component mixture was pulverized using a supersonic jet pulverizer (LABOJET from Nippon Pneumatic Mfg. Co., Ltd.) while controlling the air pressure, followed by classification using an airflow classifier (MDS-1 from Nippon Pneumatic Mfg. Co., Ltd.) while controlling the angle of the louver so that the resultant toner particles have a weight average particle diameter of 6.0+0.2 μm, and a ratio (Dw/Dn) (weight average particle diameter (Dw)/number average particle diameter (Dn)) of not greater than 1.20. Thus, a mother toner (i.e., toner particles) of a transparent toner 1 was prepared.

The following components were mixed using a HENSCHEL MIXER mixer.

| | |
|---|---|
| Mother toner prepared above | 100 parts |
| External additive | 1.0 part |
| (silica, HDK-2000 from Clariant Japan K.K.) | |

Thus, the transparent toner 1 was prepared.

### 3-2 Preparation of Transparent Toner 2

The procedure for preparation of the transparent toner 1 was repeated except that the added amount of the crystalline polyester resin A was changed from 15 parts to 30 parts.

Thus, a transparent toner 2 was prepared.

### 3-3 Preparation of Transparent Toner 3

The procedure for preparation of the transparent toner 1 was repeated except that the toner components were replaced with the following components.

| | |
|---|---|
| Polyester resin B | 100 parts |
| Carnauba wax | 5 parts |
| (CARNAUBA WAX No. 1 from CERARICA | |
| NODA Co., Ltd.) | |

Thus, a transparent toner 3 was prepared.

### 3-4 Preparation of Transparent Toner 4

The procedure for preparation of the transparent toner 1 was repeated except that the toner components were replaced with the following components.

| | |
|---|---|
| Polyester resin B | 100 parts |
| Carnauba wax | 3 parts |
| (CARNAUBA WAX No. 1 from CERARICA | |
| NODA Co., Ltd.) | |

Thus, a transparent toner 4 was prepared.

### 3-5 Preparation of Transparent Toner 5

The procedure for preparation of the transparent toner 1 was repeated except that the toner components were replaced with the following components.

| | |
|---|---|
| Polyester resin A | 100 parts |
| Crystalline polyester resin B | 20 parts |

Thus, a transparent toner 5 was prepared.

### 3-6 Preparation of Transparent Toner 6

The following components were mixed.

| | |
|---|---|
| Water | 100 parts |
| Aqueous dispersion of vinyl resin | 10 parts |
| (Copolymer of styrene/methacrylic acid/butyl | |
| acrylate/sodium salt of sulfate of ethylene oxide adduct of | |
| methacrylic acid prepared by Sanyo Chemical Industries Ltd., | |
| solid content of 20% by weight) | |
| Aqueous solution of a sodium salt of | 20 parts |
| dodecyldiphenyletherdisulfonic acid | |
| (ELEMINOL MON-7 from Sanyo Chemical Industries | |
| Ltd., solid content of 50%) | |
| 1% aqueous solution of polymeric protective | 40 parts |
| colloid | |
| (Carboxymethyl cellulose, CELLOGEN BSH from | |
| Dai-ichi Kogyo Seiyaku Co., Ltd.) | |
| Ethyl acetate | 15 parts |

Thus, a milk white liquid (i.e., aqueous phase liquid) was prepared.

The following components were fed into a container equipped with an agitator and a thermometer.

| | |
|---|---|
| Polyester resin A | 250 parts |
| Carnauba wax | 40 parts |
| Ethyl acetate | 200 parts |

The mixture was heated to 80° C. while agitated. After the mixture was heated for 5 hours at 80° C., the mixture was cooled to 30° C. over 1 hour, and then subjected to a dispersing treatment using a bead mill (ULTRAVISCOMILL from Aimex Co., Ltd.). The dispersing conditions were as follows.

Liquid feeding speed: 1.2 kg/hour

Peripheral speed of disc: 10 m/sec

Dispersing media: zirconia beads with a diameter of 0.5 mm

Filling factor of beads: 80% by volume

Repeat number of dispersing operation: 5 times (5 passes)

Thus, a wax dispersion was prepared.

Next, the following components were fed into a container.

| | |
|---|---|
| Aqueous phase liquid prepared above | 1250 parts |
| Wax dispersion prepared above | 1110 parts |
| 50% ethyl acetate solution of prepolymer | 130 parts |
| (number average molecular weight of 6,500, glass transition | |
| temperature (Tg) of 55° C., and free isocyanate content | |
| of 1.5% by weight) | |
| Isobutyl alcohol | 1 part |
| Isophorone diamine | 7 parts |
| Emulsion stabilizer | 5 parts |
| (UCAT660M from Sanyo Chemical Industries Ltd.) | |

The mixture was agitated for 30 minutes at 28° C. using a TK HOMOMIXER mixer from Tokushu Kika Kogyo Co., Ltd., whose rotor was rotated at a revolution of 9,000 rpm. Thus, an emulsion was prepared.

After the emulsion was heated to 58° C., the emulsion was further dispersed for 1 hour using the TK HOMOMIXER mixer, whose rotor was rotated at a revolution of 1,500 rpm. Thus, a slurry-like emulsion was prepared.

The slurry-like emulsion was fed into a container equipped with an agitator and a thermometer, and agitated for 10 hours at 35° C. to remove the organic solvent therefrom, followed by aging for 12 hours at 45° C. Thus, a dispersion was prepared

One hundred (100) parts of the thus prepared dispersion was subjected to filtration under a reduced pressure.

The thus prepared wet cake was mixed with 300 parts of ion-exchange water, and the mixture was agitated for 15 minutes with a TK HOMOMIXER mixer, whose rotor was rotated at a revolution of 6,000 rpm, followed by filtration under a reduced pressure. Thus, a wet cake (a) was prepared.

The thus prepared wet cake (a) was mixed with 100 parts of a 10% aqueous solution of sodium hydroxide, and the mixture was agitated for 15 minutes with the TK HOMOMIXER mixer, whose rotor was rotated at a revolution of 6,000 rpm, followed by filtration under a reduce pressure. Thus, a wet cake (b) was prepared. The wet cake (b) was mixed with 100 parts of a 10% aqueous solution of hydrochloric acid, and the mixture was agitated for 15 minutes with the TK HOMOMIXER mixer, whose rotor was rotated at a revolution of 6,000 rpm, followed by filtration under a reduce pressure. Thus, a wet cake (c) was prepared. The wet cake (c) was mixed with 500 parts of ion-exchange water, and the mixture was agitated for 30 minutes with the TK HOMOMIXER mixer, whose rotor was rotated at a revolution of 6,000 rpm, followed by filtration under a reduced pressure.

The thus prepared wet cake was dried for 24 hours at 40° C. using a circulating air drier, followed by sieving with a screen having openings of 75 μm.

Thus, a mother toner of a transparent toner 6 having a weight average particle diameter of 5.2 μm and a Mw/Mn ratio of 1.14 was prepared.

One hundred (100) parts of the mother toner was mixed with 1.0 part of an additive (silica, HDK-2000 from Clariant Japan K.K.) using a HENSCHEL MIXER mixer. Thus, the transparent toner 6 was prepared.

### 3-7 Preparation of Transparent Toner 7

The following components were mixed.

| | |
|---|---|
| Water | 100 parts |
| Aqueous dispersion of vinyl resin | 10 parts |
| (Copolymer of styrene/methacrylic acid/butyl | |
| acrylate/sodium salt of sulfate of ethylene oxide adduct of | |
| methacrylic acid prepared by Sanyo Chemical Industries Ltd., | |
| solid content of 20% by weight) | |
| Aqueous solution of a sodium salt of | 20 parts |
| dodecyldiphenyletherdisulfonic acid | |
| (ELEMINOL MON-7 from Sanyo Chemical Industries | |
| Ltd., solid content of 50%) | |
| 1% aqueous solution of polymeric protective | 40 parts |
| colloid | |
| (Carboxymethyl cellulose, CELLOGEN BSH from Dai-ichi | |
| Kogyo Seiyaku Co., Ltd.) | |
| Ethyl acetate | 15 parts |

Thus, a milk white liquid (i.e., aqueous phase liquid) was prepared.

The following components were fed into a four-necked flask equipped with a nitrogen feed pipe, a dewatering conduit, an agitator and a thermocouple.

| | |
|---|---|
| 50% ethyl acetate solution of prepolymer | 400 parts |
| (prepolymer: reaction product of condensation reaction | |
| product of propylene oxide adduct of bisphenol A/adipic | |
| acid/terephthalic acid with isophorone diisocyanate, number | |
| average molecular weight of 6,500, weight average molecular | |
| weight of 18,000, glass transition temperature of 55° C., free | |
| isocyanate content of 1.5% by weight) | |
| Condensation reaction product of propylene oxide adduct of | 100 parts |
| bisphenol A with adipic acid | |
| (number average molecular weight of 800) | |
| Isophorone diamine | 20 parts |
| Ethyl acetate | 50 parts |

The mixture was heated to 100° C. while agitated in a nitrogen atmosphere. After the mixture was subjected to a reaction for 5 hours at 100° C., the organic solvent (ethyl acetate) was removed therefrom under a reduced pressure. Thus, a polyester resin F, which is modified so as to have a urethane bond and/or a urea bond, was prepared. It was confirmed that the polyester resin F has a softening point of 104° C., a glass transition temperature (Tg) of 60° C., an acid value of 18 mgKOH/g, and a hydroxyl value of 45 mgKOH/g.

The following components were fed into a container equipped with an agitator and a thermometer.

| | |
|---|---|
| Polyester resin F | 500 parts |
| Carnauba wax | 40 parts |
| Ethyl acetate | 200 parts |

The mixture was heated to 80° C. while agitated. After the mixture was heated for 5 hours at 80° C., the mixture was cooled to 30° C. over 1 hour, and then subjected to a dispersing treatment using a bead mill (ULTRAVISCOMILL from Aimex Co., Ltd.). The dispersing conditions were as follows.

Liquid feeding speed: 1.2 kg/hour

Peripheral speed of disc: 10 m/sec

Dispersing media: zirconia beads with a diameter of 0.5 mm

Filling factor of beads: 80% by volume

Repeat number of dispersing operation: 5 times (5 passes)

Thus, a wax dispersion was prepared.

The following components were fed into a container.

| | |
|---|---|
| Aqueous phase liquid prepare above | 1420 parts |
| Wax dispersion prepared above | 1420 parts |
| Emulsion stabilizer | 5 parts |
| (UCAT660M from Sanyo Chemical Industries Ltd.) | |

The mixture was agitated for 30 minutes at 28° C. using a TK HOMOMIXER mixer (from Tokushu Kika Kogyo Co., Ltd.), whose rotor was rotated at a revolution of 9,000 rpm. Thus, a slurry-like emulsion was prepared.

The slurry-like emulsion was fed into a container equipped with an agitator and a thermometer, and agitated for 10 hours at 35° C., followed by aging for 12 hours at 45° C. to remove the organic solvent therefrom. Thus, a dispersion was prepared

One hundred (100) parts of the thus prepared dispersion was subjected to filtration under a reduced pressure.

The thus prepared wet cake was mixed with 300 parts of ion-exchange water, and the mixture was agitated for 15 minutes with a TK HOMOMIXER mixer, whose rotor was rotated at a revolution of 6,000 rpm, followed by filtration under a reduced pressure. Thus, a wet cake (a) was prepared.

The thus prepared wet cake (a) was mixed with 100 parts of a 10% aqueous solution of sodium hydroxide, and the mixture was agitated for 15 minutes with the TK HOMOMIXER mixer, whose rotor was rotated at a revolution of 6,000 rpm, followed by filtration under a reduce pressure. Thus, a wet cake (b) was prepared. The wet cake (b) was mixed with 100 parts of a 10% aqueous solution of hydrochloric acid, and the mixture was agitated for 15 minutes with the TK HOMOMIXER mixer, whose rotor was rotated at a revolution of 6,000 rpm, followed by filtration under a reduce pressure. Thus, a wet cake (c) was prepared. The wet cake (c) was mixed with 500 parts of ion-exchange water, and the mixture was agitated for 30 minutes with the TK HOMOMIXER mixer, whose rotor was rotated at a revolution of 6,000 rpm, followed by filtration under a reduced pressure.

The thus prepared wet cake was dried for 24 hours at 40° C. using a circulating air drier, followed by sieving with a screen having openings of 75 μm.

Thus, a mother toner of a transparent toner 7 having a weight average particle diameter of 5.0 μm and a Mw/Mn ratio of 1.13 was prepared.

One hundred (100) parts of the mother toner was mixed with 1.0 part of an additive (silica, HDK-2000 from Clariant Japan K.K.) using a HENSCHEL MIXER mixer.

Thus, the transparent toner 7 was prepared.

### 3-8 Preparation of Transparent Toner 8

The procedure for preparation of the transparent toner 1 was repeated except that the toner components were replaced with the following components.

| | |
|---|---|
| Polyester resin C | 100 parts |
| Carnauba wax | 5 parts |
| (CARNAUBA WAX No. 1 from CERARICA NODA Co., | |
| Ltd.) | |

Thus, a transparent toner 8 was prepared.

### 3-9 Preparation of Transparent Toner 9

The procedure for preparation of the transparent toner 1 was repeated except that the toner components were replaced with the following components.

| | |
|---|---|
| Polyester resin A | 100 parts |
| Crystalline polyester resin B | 10 parts |
| Carnauba wax | 5 parts |
| (CARNAUBA WAX No. 1 from CERARICA NODA Co., | |
| Ltd.) | |

Thus, a transparent toner 9 was prepared.

### 3-10 Preparation of Transparent Toner 10

The procedure for preparation of the transparent toner 1 was repeated except that the toner components were replaced with the following components.

| | |
|---|---|
| Polyester resin A | 100 parts |
| Crystalline polyester resin A | 15 parts |
| Carnauba wax | 5 parts |
| (CARNAUBA WAX No. 1 from CERARICA NODA Co., | |
| Ltd.) | |
| Stearamide | 2 parts |
| (FATTY ACID AMIDE S from Kao Corp.) | |

Thus, a transparent toner 10 was prepared.

### 3-11 Preparation of Transparent Toner 11

The procedure for preparation of the transparent toner 1 was repeated except that the toner components were replaced with the following components.

| | |
|---|---|
| Polyester resin D | 100 parts |
| Crystalline polyester resin A | 15 parts |
| Carnauba wax | 5 parts |
| (CARNAUBA WAX No. 1 from CERARICA NODA Co., | |
| Ltd.) | |
| Ethylenebisstearamide | 2 parts |
| (EB-P from Kao Corp.) | |

Thus, a transparent toner 11 was prepared.

### 3-12 Preparation of Transparent Toner 12

The procedure for preparation of the transparent toner 1 was repeated except that the toner components were replaced with the following components.

| | |
|---|---|
| Polyester resin E | 100 parts |
| Crystalline polyester resin A | 15 parts |
| Carnauba wax | 5 parts |
| (CARNAUBA WAX No. 1 from CERARICA NODA Co., | |
| Ltd.) | |
| Ethylenebisstearamide | 2 parts |
| (EB-P from Kao Corp.) | |

Thus, a transparent toner 12 was prepared.

The properties of the transparent toners 1-12 are illustrated in Table 3 below.

TABLE 3

| | | Addition | | Tan δ | | | | |
|---|---|---|---|---|---|---|---|---|
| No of | Addition | of | Addition | peak | | | | Mw/Mn |
| transparent | of | crys. | of | temp. | Loss | Mw of | Mn of | of |
| toner | wax | PE* | lubricant*² | (° C.) | tangent | polyester | polyester | polyester |
| 1 | Yes | Yes | Yes | 85 | 4 | 15300 | 3800 | 4.03 |
| 2 | Yes | Yes | Yes | 78 | 5 | 15300 | 3800 | 4.03 |
| 3 | Yes | No | No | 156 | 11 | 18700 | 4900 | 3.82 |
| 4 | Yes | No | No | 164 | 11 | 18700 | 4900 | 3.82 |
| 5 | No | Yes | No | 98 | 4 | 15300 | 3800 | 4.03 |
| 6 | Yes | No | No | 145 | 8 | 15300 | 3800 | 4.03 |
| 7 | Yes | No | No | 120 | 2 | — | — | — |
| 8 | Yes | No | No | 158 | 10 | 19600 | 3200 | 6.13 |
| 9 | Yes | Yes | No | 117 | 4 | 15300 | 3800 | 4.03 |
| 10 | Yes | Yes | Yes | 84 | 6 | 15300 | 3800 | 4.03 |
| 11 | Yes | Yes | Yes | 84 | 28 | 19840 | 3580 | 5.54 |
| 12 | Yes | Yes | Yes | 82 | 50 | 20800 | 3580 | 5.81 |

crys. PE*: crystalline polyester
lubricant*²: Fatty acid amide-based lubricant
Yes: The material is included in the toner.
No: The material is not included in the toner.

### 4. Preparation of Color Toners

### 4-1 Preparation of Colorant Master Batches

The following components were mixed using a HENSCHEL MIXER mixer from NIPPON COKE & ENGINEERING CO., LTD.

| | |
|---|---|
| Carbon black | 50 parts |
| (REGAL 400R from Cabot Corp.) | |
| Polyester resin | 50 parts |
| (RS801 from Sanyo Chemical Industries Ltd.) | |
| Water | 30 parts |

The mixture was kneaded for 50 minutes at 160° C. using a two roll mill. The kneaded mixture was subjected to roll cooling, and then pulverized. Thus, a black colorant master batch 1 was prepared.

The procedure for preparation of the black colorant master batch 1 was repeated except that the carbon black was replaced with C.I. Pigment Red 269, C.I. Pigment Blue 15:3, or C.I. Pigment Yellow 155 to prepare a magenta colorant master batch 1, a cyan colorant master batch 1 and a yellow colorant master batch 1.

### 4-2 Preparation of Color Toners

The procedure for preparation of the transparent toner 1 was repeated except that the toner components were replaced with the following components.

| | |
|---|---|
| Polyester resin A | 92 parts |
| Crystalline polyester resin A | 15 parts |
| Carnauba wax | 4 parts |
| (CARNAUBA WAX No. 1 from CERARICA NODA Co., Ltd.) | |
| Black colorant master batch 1 | 16 parts |

Thus, a black toner 1 was prepared.

The procedure for preparation of the black toner 1 was repeated except that the black colorant master batch 1 was replaced with the magenta, cyan or yellow master batch to prepare a magenta toner 1, a cyan toner 1 and a yellow toner 1.

### Example 1

### (1) Preparation of Developers

The following components were mixed.

| | |
|---|---|
| Transparent toner 1 | 5 parts |
| Coated ferrite carrier | 95 parts |

The mixture was mixed for 5 minutes using a TURBULA MIXER mixer from Willy A. Bachofen AG (WAB), which was rotated at a revolution of 48 rpm, to charge the toner.

Thus, a developer T1 including the transparent toner 1 was prepared.

The procedure for preparation of the developer T1 was repeated except that the transparent toner 1 was replaced with the black toner 1, the magenta toner 1, the cyan toner 1 or the yellow toner 1 to prepare black, magenta, cyan and yellow developers K1, M1, C1 and Y1.

### (2) Preparation of Supplementary Developers

The following components were mixed.

| | |
|---|---|
| Transparent toner 1 | 80 parts |
| Coated ferrite carrier | 20 parts |

The mixture was mixed for 5 minutes using a TURBULA MIXER mixer from Willy A. Bachofen AG (WAB), which was rotated at a revolution of 48 rpm, to charge the toner.

Thus, a supplementary developer TS1 including the transparent toner 1 was prepared.

The procedure for preparation of the developer TS1 was repeated except that the transparent toner 1 was replaced with the black toner 1, the magenta toner 1, the cyan toner 1 or the yellow toner 1 to prepare supplementary black, magenta, cyan and yellow developers KS1, MS1, CS1 and YS1.

The thus prepared toners and developers were evaluated as follows

### 1. Fixing Property

The developer T1 including the transparent toner 1 was set in the developing unit 105E of the image forming apparatus illustrated in FIG. 1, and the yellow, magenta, cyan and black developers Y1, M1, C1 and K1 were respectively set in the developing units 105A, 105B, 105C and 105D. Each of the developing units 105A-105E is equipped with the developer supplying device 200 illustrated in FIG. 2, and the supplementary developers YS1, MS1, CS1, KS1 and TS1 were contained in the developer containers 230 of the corresponding developer supplying devices.

By using the image forming apparatus, the image forming processes, i.e., charging, irradiating, developing, transferring and fixing processes, were performed to produce color images in which a solid transparent image with a weight of 0.4 mg/cm² was formed on a solid color toner image with a weight of 0.4 mg/cm². The image forming conditions were as follows.

Image forming speed (linear speed): 160 mm/sec

Fixing temperature: 130 to 210° C. (standard temperature: 190° C.)

Fixing nip width: 11 mm

Recording paper: POD GLOSS COAT PAPER from Oji Paper Co., Ltd., which has a weight of 128 g/m²

In order to evaluate the fixability of toner, the following properties were evaluated.

### (1) Low Temperature Fixability

Images were produced while changing the fixing temperature from 130 to 200° C. at an interval of 5° C. The produced images were visually observed to determine whether the toners cause a cold offset phenomenon and a hot offset phenomenon (i.e., to evaluate the low temperature fixability and the hot offset resistance of the toner). The low temperature fixability of toner is graded as follows.

⊚: The cold offset temperature of the toner is lower than 130° C. (excellent)
◯: The cold offset temperature of the toner is lower than 140° C. and not lower than 130° C. (good)
□: The cold offset temperature of the toner is lower than 150° C. and not lower than 140° C. (fair)
Δ: The cold offset temperature of the toner is lower than 160° C. and not lower than 150° C. (acceptable)
X: The cold offset temperature of the toner is not lower than 160° C. (bad)

### (2) Hot Offset Resistance

The procedure for evaluation of the low temperature fixability was repeated, and the produced images were visually observed to determine whether the toners cause the hot offset phenomenon. The hot offset resistance of toner is graded as follows.

⊚: The hot offset temperature of the toner is higher than 200° C. (excellent)
◯: The hot offset temperature of the toner is higher than 190° C. and not higher than 200° C. (good)
□: The hot offset temperature of the toner is higher than 180° C. and not higher than 190° C. (fair)
Δ: The hot offset temperature of the toner is higher than 170° C. and not higher than 180° C. (acceptable)
X: The hot offset temperature of the toner is not higher than 170° C. (bad)

### (3) Glossiness of Fixed Toner Images

The glossiness (60° glossiness) of the fixed toner images was measured with a gloss meter VGS-1D from Nippon Denshoku Industries Co., Ltd. The glossiness property of toner is graded as follows.

⊚: The glossiness of the fixed toner image is not lower than 80%. (excellent)
◯: The glossiness of the fixed toner image is not lower than 60% and lower than 80%. (good)
Δ: The glossiness of the fixed toner image is not lower than 40% and lower than 60%. (acceptable)
X: The glossiness of the fixed toner image is lower than 40%. (bad)

### (4) Unevenness of Glossiness of Fixed Toner Images

The fixed toner images were visually observed to determine unevenness of glossiness of the images.

In addition, a running test, in which 50,000 copies of an original image are continuously produced, was performed on each of the developers while supplying the corresponding supplementary developer, and the last image was visually observed to determine unevenness of glossiness of the image. The unevenness of glossiness is graded as follows.

⊚: The fixed toner image has no unevenness of glossiness. (excellent)
◯: The fixed toner image has slight unevenness of glossiness. (good)
Δ: The fixed toner image has unevenness of glossiness on an acceptable level. (acceptable)
X: The fixed toner image has serious unevenness of glossiness. (bad)

### 3. Preservation Property of the Toners

Ten (10) grams of each of the toners was fed into a 30 ml screw vial, and the screw vial was tapped 100 times by a tapping machine. After the screw vial containing the toner was preserved for 24 hours at 45° C. and then cooled to room temperature, the penetration of the toner was measured using a penetration tester. The preservation property of the toner is graded as follows.

◯: The penetration of the toner is not lower than 15 mm. (good)
Δ: The penetration of the toner is not lower than 10 mm and is lower than 15 mm. (acceptable)
X: The penetration of the toner is lower than 10 mm. (bad)

### Comparative Example 1

The procedure for preparation and evaluation of the developers in Example 1 was repeated except that the transparent toner 1 was replaced with the transparent toner 2.

### Example 2

The procedure for preparation and evaluation of the developers in Example 1 was repeated except that the transparent toner 1 was replaced with the transparent toner 3.

### Comparative Example 2

The procedure for preparation and evaluation of the developers in Example 1 was repeated except that the transparent toner 1 was replaced with the transparent toner 4.

### Comparative Example 3

The procedure for preparation and evaluation of the developers in Example 1 was repeated except that the transparent toner 1 was replaced with the transparent toner 5.

### Comparative Example 4

The procedure for preparation and evaluation of the developers in Example 1 was repeated except that the supplementary transparent developer TS1 was replaced with the transparent toner 1 (i.e., the supplementary transparent developer contained in the container 230 includes no carrier) and therefore discharging of excess of the developer from the developing unit 105E was not performed.

### Example 3

The procedure for preparation and evaluation of the developers in Example 1 was repeated except that the solid transparent toner image was initially formed on the recording material and then a solid color toner image was formed thereon (i.e., the positions of the transparent toner image and a color toner image are reversed).

### Example 4

The procedure for preparation and evaluation of the developers in Example 1 was repeated except that the transparent toner 1 was replaced with the transparent toner 6.

### Comparative Example 5

The procedure for preparation and evaluation of the developers in Example 1 was repeated except that the transparent toner 1 was replaced with the transparent toner 7.

### Example 5

The procedure for preparation and evaluation of the developers in Example 1 was repeated except that the transparent toner 1 was replaced with the transparent toner 8.

### Example 6

The procedure for preparation and evaluation of the developers in Example 1 was repeated except that the transparent toner 1 was replaced with the transparent toner 9.

### Example 7

The procedure for preparation and evaluation of the developers in Example 1 was repeated except that the transparent toner 1 was replaced with the transparent toner 10.

### Example 8

The procedure for preparation and evaluation of the developers in Example 1 was repeated except that the transparent toner 1 was replaced with the transparent toner 11.

### Example 9

The procedure for preparation and evaluation of the developers in Example 1 was repeated except that the transparent toner 1 was replaced with the transparent toner 12.

### Example 10

The procedure for preparation and evaluation of the developers in Example 1 was repeated except that the weight of the solid transparent toner image was changed to 0.05 mg/cm². In this regard, the thickness of the fixed transparent toner image was 0.5 μm.

### Example 11

The procedure for preparation and evaluation of the developers in Example 1 was repeated except that the weight of the solid transparent toner image was changed to 0.1 mg/cm². In this regard, the thickness of the fixed transparent toner image was 2 μm.

### Example 12

The procedure for preparation and evaluation of the developers in Example 1 was repeated except that the weight of the solid transparent toner image was changed to 1.2 mg/cm². In this regard, the thickness of the fixed transparent toner image was 14 μm.

### Example 13

The procedure for preparation and evaluation of the developers in Example 1 was repeated except that the weight of the solid transparent toner image was changed to 1.5 mg/cm². In this regard, the thickness of the fixed transparent toner image was 16 μm.

### Example 14

The procedure for preparation and evaluation of the developers in Example 1 was repeated except that the supplementary developer TS1 was replaced with a supplementary developer TS2 which was prepared by repeating the procedure for preparation of the supplementary developer TS1 except that the weight ratio of the transparent toner T1 to the coated ferrite carrier in the supplementary developer was changed from 80/20 to 98/2.

### Example 15

The procedure for preparation and evaluation of the developers in Example 1 was repeated except that the supplementary developer TS1 was replaced with a supplementary developer TS3 which was prepared by repeating the procedure for preparation of the supplementary developer TS1 except that the weight ratio of the transparent toner T1 to the coated ferrite carrier in the supplementary developer was changed from 80/20 to 69/31.

### Example 16

The procedure for preparation and evaluation of the developers in Example 1 was repeated except that the developer T1 was replaced with a developer T2 which was prepared by repeating the procedure for preparation of the developer T1 except that the weight ratio of the transparent toner T1 to the coated ferrite carrier in the developer was changed from 5/95 to 16/84.

### Example 17

The procedure for preparation and evaluation of the developers in Example 1 was repeated except that the developer T1 was replaced with a developer T3 which was prepared by repeating the procedure for preparation of the developer T1 except that the weight ratio of the transparent toner T1 to the coated ferrite carrier in the developer was changed from 5/95 to 1/99.

The evaluation results are shown in Table 4-1 and 4-2.

TABLE 4-1

| | | | | | | Content |
|---|---|---|---|---|---|---|
| | | | | Thickness | Content | of |
| | | | | of | of | carrier |
| | | | | the | carrier | in the |
| | No. of | | Outermost | outermost | in the | supplementary |
| | transParent | Supplementary | toner | layer | developer | developer |
| | toner | developer* | layer*² | (μm) | (wt %) | (wt %) |
| Ex. 1 | 1 | DEV | T | 7 | 95 | 20 |
| Comp. | 2 | DEV | T | 7 | 95 | 20 |
| Ex. 1 | | | | | | |
| Ex. 2 | 3 | DEV | T | 7 | 95 | 20 |
| Comp. | 4 | DEV | T | 7 | 95 | 20 |
| Ex. 2 | | | | | | |
| Comp. | 5 | DEV | T | 7 | 95 | 20 |
| Ex. 3 | | | | | | |
| Comp. | 1 | TONER | T | 7 | 95 | 0 |
| Ex. 4 | | | | | | |
| Ex. 3 | 1 | DEV | C | 7 | 95 | 20 |
| Ex. 4 | 6 | DEV | T | 7 | 95 | 20 |
| Comp. | 7 | DEV | T | 7 | 95 | 20 |
| Ex. 5 | | | | | | |
| Ex. 5 | 8 | DEV | T | 7 | 95 | 20 |
| Ex. 6 | 9 | DEV | T | 7 | 95 | 20 |
| Ex. 7 | 10 | DEV | T | 7 | 95 | 20 |
| Ex. 8 | 11 | DEV | T | 7 | 95 | 20 |
| Ex. 9 | 12 | DEV | T | 7 | 95 | 20 |
| Ex. 10 | 1 | DEV | T | 0.5 | 95 | 20 |
| Ex. 11 | 1 | DEV | T | 2 | 95 | 20 |
| Ex. 12 | 1 | DEV | T | 14 | 95 | 20 |
| Ex. 13 | 1 | DEV | T | 16 | 95 | 20 |
| Ex. 14 | 1 | DEV | T | 7 | 95 | 2 |
| Ex. 15 | 1 | DEV | T | 7 | 95 | 31 |
| Ex. 16 | 1 | DEV | T | 7 | 84 | 20 |
| Ex. 17 | 1 | DEV | T | 7 | 99 | 20 |

Supplementary developer*
DEV: The supplementary developers TS1, KS1, MS1, CS1 and YS1 were supplied to the developers in the developing devices while discharging excess of the developers.
TONER: The transparent toner T1 was used as the supplementary developer (i.e., the carrier was not included in the supplementary developer), and the other supplementary developers KS1, MS1, CS1 and YS1 were used as the supplementary developers.
Outermost toner layer*² T: The transparent toner layer is the outermost layer. C: A color toner layer is the outermost layer.

TABLE 4-2

| | | | | | | Unevenness |
|---|---|---|---|---|---|---|
| | | | | | | of |
| | | | | | Unevenness | glossiness |
| | Low | Hot | | | of | (after |
| | temp. | offset | | | glossiness | running |
| | fixability | resistance | Preservability | Glossiness | (initial) | test) |
| Ex. 1 | ⊚ | ⊚ | Δ | ⊚ | ⊚ | ⊚ |
| Comp. | ⊚ | X | X | ⊚ | ⊚ | ⊚ |
| Ex. 1 | | | | | | |
| Ex. 2 | Δ | ⊚ | ◯ | ◯ | ◯ | ◯ |
| Comp. | X | ⊚ | ◯ | ◯ | Δ | Δ |
| Ex. 2 | | | | | | |
| Comp. | ⊚ | X | ◯ | ◯ | Δ | Δ |
| Ex. 3 | | | | | | |
| Comp. | ⊚ | ⊚ | ◯ | ⊚ | ⊚ | X |
| Ex. 4 | | | | | | |
| Ex. 3 | ⊚ | ⊚ | ◯ | Δ | ◯ | ◯ |
| Ex. 4 | □ | ⊚ | ◯ | ◯ | ◯ | ◯ |
| Comp. | X | X | ◯ | ◯ | ◯ | ◯ |
| Ex. 5 | | | | | | |
| Ex. 5 | Δ | ⊚ | ◯ | Δ | ◯ | ◯ |
| Ex. 6 | ◯ | ⊚ | ◯ | ◯ | ⊚ | ⊚ |
| Ex. 7 | ⊚ | ⊚ | ◯ | ⊚ | ⊚ | ⊚ |
| Ex. 8 | ⊚ | ◯ | ◯ | ⊚ | ⊚ | ⊚ |
| Ex. 9 | ⊚ | □ | ◯ | ⊚ | ⊚ | ⊚ |
| Ex. | ⊚ | ◯ | ◯ | Δ | Δ | Δ |
| 10 | | | | | | |
| Ex. | ⊚ | ⊚ | ◯ | ◯ | ◯ | ◯ |
| 11 | | | | | | |
| Ex. | ⊚ | ⊚ | ◯ | ⊚ | ⊚ | ⊚ |
| 12 | | | | | | |
| Ex. | ⊚ | ⊚ | ◯ | ⊚ | ◯ | ◯ |
| 13 | | | | | | |
| Ex. | ⊚ | ⊚ | ◯ | ⊚ | ⊚ | Δ |
| 14 | | | | | | |
| Ex. | ⊚ | ⊚ | ◯ | ⊚ | ⊚ | Δ |
| 15 | | | | | | |
| Ex. | ⊚ | ⊚ | ◯ | ⊚ | Δ | ⊚ |
| 16 | | | | | | |
| Ex. | ⊚ | ⊚ | ◯ | Δ | Δ | ◯ |
| 17 | | | | | | |

It is clearly understood from Tables 1-4 that by using the image forming method of the present invention, glossy images can be stably produced for a long period of time without causing the offset problems and without deteriorating the carrier used in combination with the toner. The transparent toner layer is preferably formed as an outermost layer to enhance the glossiness of images.

When a polyester resin having a Mw/Mn ratio of not greater than 6 is used for the transparent toner, the glossiness of images can be enhanced. In addition, when a crystalline polyester resin is used for the transparent toner, the low temperature fixability can be enhanced.

When a fatty acid amide-based lubricant is included in the transparent toner, the preservability of the toner can be enhanced as can be understood from comparison of the transparent toner 1 (Example 1) with the transparent toner 10 (Example 7).

When the thickness of the fixed transparent toner layer located on a color toner image is from 1 to 15 μm, glossy images can be produced.

In addition, when the content of the carrier in the supplementary developer is from 3% to 30% by weight, the carrier supplement effect can be produced (i.e., images having good evenness of glossiness can be produced). When the content of the carrier in the developer in the developing device is from 85% to 98% by weight, glossy images having good image qualities can be stably produced.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Applications Nos. 2010-155195 and 2011-081535, filed on Jul. 7, 2010, and Apr. 1, 2011, respectively, the entire contents of which are herein incorporated by reference.

What is claimed is:

1. An image forming method comprising:
developing an electrostatic latent image on a first image bearing member with a first developer, which includes a color toner and a first carrier including a core material and a cover layer located on the core material and which is contained in a first developing device, to form a color toner image on the first image bearing member;
developing another electrostatic latent image on the first image bearing member or a second image bearing member with a second developer, which includes a transparent toner and the first carrier or a second carrier including a core material and a cover layer located on the core material and which is contained in a second developing device, to form a transparent toner image on the first or second image bearing member;
transferring the color toner image and the transparent toner image onto a recording material to form a combined toner image in which the color toner image and the transparent toner image are partially or entirely overlapped;
fixing the combined toner image on the recording material; and
supplying a supplementary developer including the transparent toner and the first or second carrier to the second developing device while discharging excess of the second developer in the second developing device,
wherein the transparent toner includes a resin and a lubricant and has a viscoelastic property such that a loss tangent (tan δ), which is defined as a ratio (G″/G′) of loss modulus (G″) to storage modulus (G′), has a peak at a temperature of from 80° C. to 160° C. and the peak has a height of not less than 3.

2. The image forming method according to claim 1, wherein the transparent toner image is present as an outermost layer of the fixed combined toner image on the recording material.

3. The image forming method according to claim 1, wherein the resin of the transparent toner includes a thermoplastic polyester resin, and wherein a ratio (Mw/Mn) of a weight average molecular weight (Mw) of the polyester resin to a number average molecular weight (Mn) thereof is not greater than 6.

4. The image forming method according to claim 1, wherein the resin of the transparent toner includes a thermoplastic crystalline polyester resin.

5. The image forming method according to claim 1, wherein the lubricant of the transparent toner includes a fatty acid amide-based lubricant.

6. The image forming method according to claim 1, wherein the fixed transparent toner image has a thickness of from 1 μm to 15 μm.

7. A two-component developer comprising:
a transparent toner including a resin and a lubricant, and has a viscoelastic property such that a loss tangent (tan δ), which is defined as a ratio (G″/G′) of loss modulus (G″) to storage modulus (G′), has a peak at a temperature of from 80° C. to 160° C. and the peak has a height of not less than 3; and
a carrier including a core material and a cover layer located on the core material.

8. The two-component developer according to claim 7, used as a supplementary developer, wherein a weight ratio (C/T) of the carrier (C) to the transparent toner (T) is from 3/97 to 30/70.

9. The two-component developer according to claim 7, used as a developer for developing an electrostatic latent image, wherein a weight ratio (C/T) of the carrier (C) to the transparent toner (T) is from 85/15 to 98/2.

10. An image forming apparatus comprising:
at least one image bearing member;
a first developing device to develop an electrostatic latent image on the at least one image bearing member with a first developer including a color toner and a first carrier including a core material and a cover layer located on the core material to form a color toner image thereon;
a second developing device to develop an electrostatic latent image on the at least one image bearing member with the two-component developer according to claim 7 to form a transparent toner image thereon;
a developer supplying device to supply a supplementary developer including the transparent toner and the carrier of the two-component developer to the second developing device, wherein the developer supplying device includes:
a developer container to contain the supplementary developer;
a suction pump to suck the supplementary developer in the developer container to feed the supplementary developer to the second developing device;
a transferring device to transfer the color toner image and the transparent toner image onto a recording material to form a combined toner image in which the color toner image and the transparent toner image are partially or entirely overlapped; and
a fixing device to fix the combined toner image on the recording material,
wherein the second developing device discharges excess of the developer therein upon receipt of the supplementary developer from the developer supplying device.

11. A process cartridge comprising:
an image bearing member; and
a developing device to develop an electrostatic latent image on the image bearing member with the two-component developer according to claim 7 to form a transparent toner image thereon, wherein the developing device receives a supplementary developer including the transparent toner and the carrier from outside while discharging excess of the developer in the developing device;
wherein the image bearing member and the developing device are integrated into a single unit so as to be detachably attachable to an image forming apparatus.
